(19) United States
(12) Patent Application Publication
(10) Pub. No.: US 2003/0014227 A1
(43) Pub. Date: Jan. 16, 2003

(54) Method and apparatus for analyzing physical target system and computer program product therefor

(76) Inventors: Kenzo Gunyaso, Kawasaki-ku (JP); Tsuneyuki Hiramoto, Kawasaki-ku (JP)

Correspondence Address: Cooper & Dunham LLP, 1185 Avenue of the Americas, New York, NY, 10036, US

(21) Appl. No.: 10/103,634

(22) Filed: Mar. 20, 2002

(30) Foreign Application Priority Data
Apr. 12, 2001 (JP) 2001-114267

(51) Int. Cl. G06F 17/10

(52) U.S. Cl. 703/2

(57) ABSTRACT

In order to analyze a physical target system, a simultaneous equation for the analysis is converted into a first equation in a matrix form to be divided into a plurality of groups. After that, for each group, an unknown vector having connective relation of the adjacent group is added to a constant vector, whereby an addition vector is generated, and a second equations each in the matrix form is generated. The equation having connective relation is extracted from the second equations, thereby generating at least one of compressed third equation in the matrix form. Values of unknowns included in the unknown vector are obtained by using an inverse matrix of a coefficient matrix. These values are substituted into the second equations, thereby obtaining values of the unknowns included in the simultaneous linear equation. These values are outputted as an analysis result of the target system.

### CROSS-REFERENCE TO RELATED APPLICATIONS

This application is based upon and claims the benefit of priority from the prior Japanese Patent Application No. 2001-114267, filed Apr. 12, 2001, the entire contents of which are incorporated herein by reference.

### BACKGROUND OF THE INVENTION

1. Field of the Invention

The present invention relates to a method and apparatus for analyzing a physical target system and a computer program product therefor.

2. Description of the Related Art

In order to analyze a physical phenomenon such as a vibration transmission state or a room temperature distribution state, in general, a multi-dimensional, simultaneous linear equation must be solved. In order to solve such multi-dimensional, simultaneous linear equation, an inverse matrix is computed. When a computer computes such inverse matrix, there are difficulties that the size of matrix that can be handled by analysis software is limited, and a tremendously large amount of time is required for computing a large matrix.

A computational technique for eliminating such a difficulty is disclosed in the U.S. Pat. No. 5,442,569 specification, “Method and apparatus for system characterization and analysis using finite element methods”. In this computational technique, first, a multi-dimensional, simultaneous linear equation is divided into “n” groups. Unknowns included in groups each are divided into three types, E, U, and I. Type I denotes unknowns that exist in its own group. Type E denotes unknowns essentially included in its own group and the unknowns being included also in other groups. Type U denotes unknowns essentially included in other group and the unknowns being included also in its own group. Next, the unknowns included in some of the n groups are merged, respectively, for types I, E, and U each. Similarly, the unknowns included in the remaining of the n groups are merged for types I, E, and U each. The thus merged unknowns for types I, E, and U are merged in all, and are integrated into one group. A first simultaneous linear equation including only the known numbers for types E and U is produced from the unknowns integrated into one group of unknowns. A first simultaneous linear equation is generated from the group of unknowns integrated into the group, which includes only unknowns for type E and U. The first simultaneous linear equation is solved and the unknowns for types E and U are obtained. The obtained unknowns for types E and U are substituted into a second simultaneous linear equation including only the unknowns for type I, and the unknowns for type I are obtained.

If a multi-dimensional, simultaneous linear equation is solved by this technique, it is possible to obtain values of all the unknowns within a short time even when the number of unknowns is very large. Therefore, dividing and merging for types of unknowns each are repeated in order to solve the multi-dimensional, simultaneous linear equation in the technique disclosed in the U.S. Pat. No. 5,442,569. Such dividing/merging process of unknowns must be thoughtfully carried out to finally solve the multi-dimensional, simultaneous linear equation, and thus, very high technical knowledge and experience is required.

In order to carry out closer three-dimensional irregular analysis using physical analysis simulation such as vibration analysis, structural analysis, heat transmission analysis, or fluid analysis, there must be repeatedly carried out: (a) setting a variety of analysis conditions such as initial conditions and boundary conditions; (b) computing a response of a next time under the analysis conditions; and (c) computing a response of a next time while the computed response is set as a condition. Thus, merely setting arbitrary time conditions for a time coordinate system cannot carry out detailed analysis. In order to carry out detailed three-dimensional irregular analysis, it is necessary to solve a simultaneous linear equation that includes a very large number of unknowns such as 100,000 to 1,000,000, for example, considering a time coordinate system.

### BRIEF SUMMARY OF THE INVENTION

It is an object of the present invention to provide a method and apparatus for analyzing a physical target system and a computer program product therefor by solving a simultaneous equation including a plenty of unknowns at a high speed without requiring high-level technical knowledge or experience.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

According to one aspect of the present invention, a simultaneous equation to analyze a physical target system is converted into a first equation in the form of “first coefficient matrix×first unknown vector=first constant vector”. The first equation is divided into a plurality of groups. A first unknown vector having connective relation of the other adjacent group is added to the first constant vector for each group of the first equation, thereby an addition vector is generated. By using the first unknown vector, the addition vector, and an inverse matrix of the first coefficient matrix, a plurality of second equations each in the form of “first unknown vector=inverse matrix of first coefficient matrix×addition vector” is generated, corresponding to each group of the first equation, respectively. An equation having connective relation is extracted from each of the second equations, thereby a compressed third equation in the form of “second coefficient matrix×second unknown vector=second constant vector” is generated. By using an inverse matrix of the second coefficient matrix, values of unknowns included in the second unknown vector are obtained. The obtained values of the unknowns included in the second unknown vector are substituted into the plurality of the second equations; thereby values of unknowns included in the simultaneous linear equation are obtained. The obtained values of the unknowns included in the simultaneous linear equation are outputted as an analysis result of the target system.

According to another aspect of the present invention, dividing the first equation into a plurality of groups, generating the first addition vector, generating a plurality of second equations each, and generating the third equation are repeated the count N times by replacing the first equation with the third equation. Obtaining values of unknowns included in the second unknown vector by using an inverse matrix of the second coefficient matrix obtained after the repetition, and obtaining values of unknowns included in the first unknown vector by substituting the values of the unknowns included in the second unknown vector into the first equation are repeated the count N times, thereby values of unknowns included in the simultaneous linear equation are obtained.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiment given below, serve to explain the principles of the invention.

FIG. 1 is a block diagram showing a configuration of an analysis system according to one embodiment of the present invention;

FIG. 2 is a block diagram showing an example of a more specific configuration of a solver in FIG. 1;

FIGS. 3A and 3B are flowcharts showing one operating procedure of the solver in FIG. 2;

FIG. 4 is a view visually illustrating the operating procedure of the solver in FIG. 2 when one carries out vibration analysis of a target system that is a one-particle system;

FIGS. 5A and 5B are views each showing a relationship between a division number and a computation time when the solver in FIG. 2 is applied to a linear differential equation of an object at one particle receiving an external force;

FIG. 6 is a block diagram showing another example of a more specific configuration of the solver in FIG. 1;

FIGS. 7A to 7C are flow charts showing one operating procedure of the solver in FIG. 6;

FIG. 8 is a view visually illustrating the operating procedure of the solver in FIG. 6 when one carries out vibration analysis of a target system that is a one-particle system;

FIGS. 9A and 9B are views each showing a relationship between a division number and a computation time when the solver in FIG. 6 is applied to a linear differential equation of an object at one-particle receiving an external force;

FIGS. 10A and 10B are views showing an exemplary output form of a result of vibration analysis in accordance with the present embodiment; and

FIG. 11 is a view showing an exemplary output form of a result of heat transmission analysis in accordance with the present embodiment.

### DETAILED DESCRIPTION OF THE INVENTION

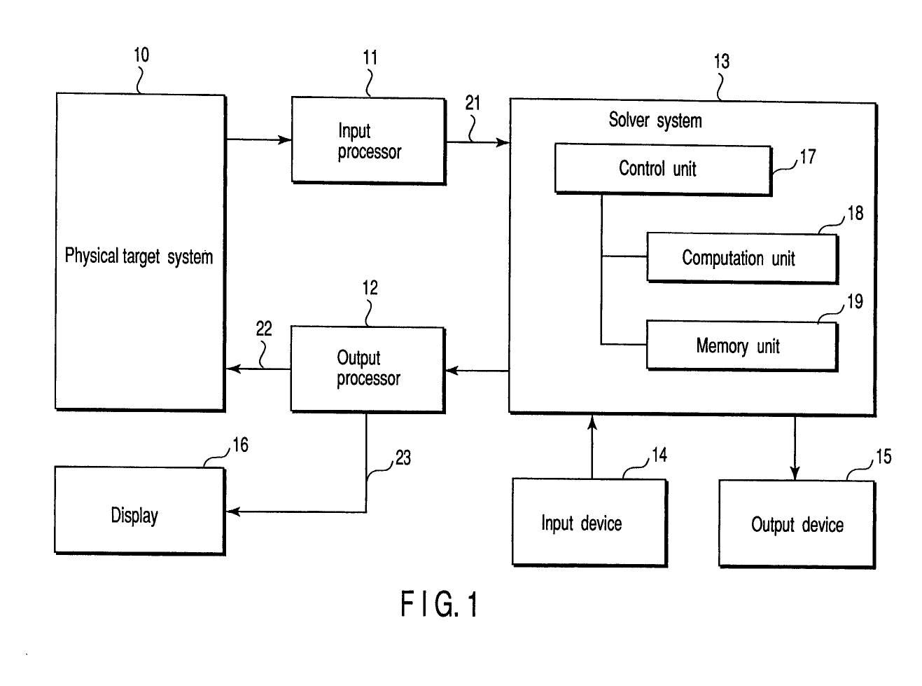

Referring to FIG. 1, for example, a physical target system 10 such as a plant is connected to a solver system 13 via an input processor 11 and an output processor 12 each having an interface function. An input device 14 and an output device 15 are connected to the solver system 13. Physical data 21 indicating an operation state of the target system 10 is acquired via the input processor 11, and is captured by the solver system 13.

In the solver system 13, analysis is carried out based on an instruction from an operator, the instruction being inputted via the input device 14. The output device 15 outputs the analysis result of the solver system 13. Based on the analysis result of the solver system 13, control data 22 is generated via the output processor 12, and the control data 22 is supplied to the target system 10. At the output processor 12, display data 23 for clarifying an operation state of the target system 10 is further generated in accordance with the analysis result, and the operation state is displayed on a display 16 by way of the display data 23.

The input device 14 is provided as a keyboard or touch panel, for example. This device is used to input initial conditions, boundary conditions, time step width, time step number, space step width, space step number, solid state property values (referred to as analysis conditions), division number, and hierarchically processed order.

The output device 15 includes a variety of displays such as a liquid crystal display, a CRT display, and a plasma display. This output device is used to display a screen prompting input of analysis conditions and division number or display the analysis result and the like. The input device 15 includes a variety of printers such as an ink jet printer or a laser printer to be used to output the analysis result as a hard copy.

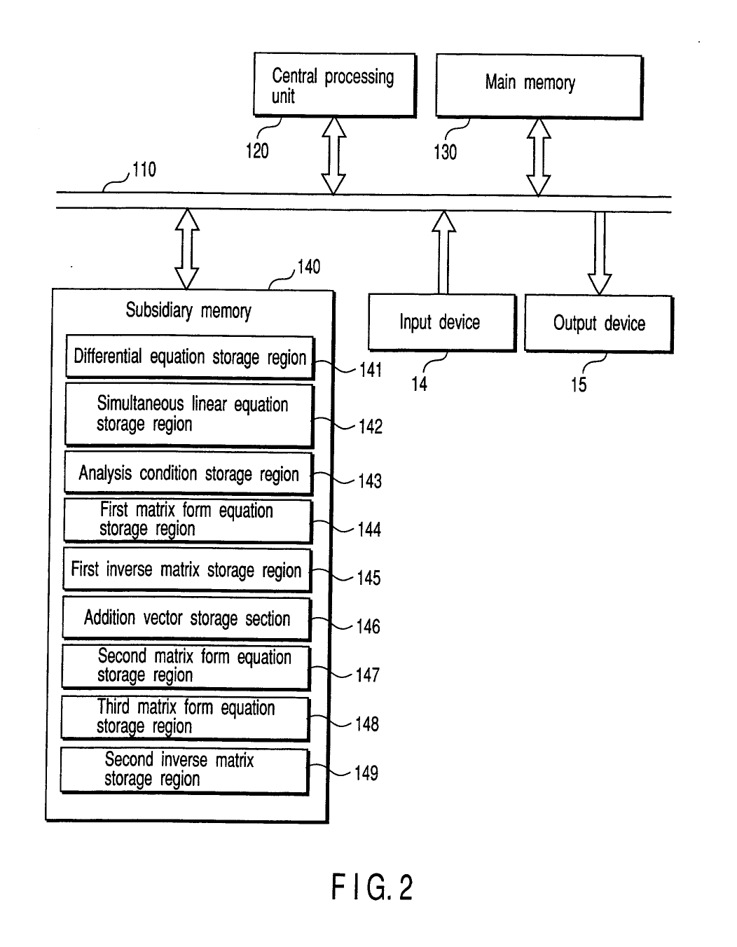

The solver system 13 has a control unit 21, a computing unit 22, and a memory unit 23. Referring to FIG. 2, more specifically, the solver system 13 is composed of a CPU (Central Processing Unit) 120, a main memory 130, and a subsidiary memory 140, each of which is connected to a bus 110. The CPU 120 achieves functions of the control unit 21 and computing unit 22. The memory unit 23 includes the main memory 130 and subsidiary memory 140.

The main memory 130 is provided as a device for storing a computation program of a simultaneous linear equation in accordance with the present embodiment. Specifically, a RAM and a ROM are used. The CPU 120 obtains a solution of a simultaneous linear equation by using the analysis conditions and division number inputted from the input device 14 in accordance with a computation program of a simultaneous linear equation stored in the main memory 130. The obtained solution is outputted as the analysis result by means of the output device 15.

The subsidiary memory 140 is provided as a device for temporarily storing a value such as an inverse matrix obtained by the CPU 120 in the middle of computation for analysis. This memory is provided as a storage device such as a RAM or hard disk. The subsidiary memory 140 is classified into: a differential equation storage area 141; a multi-dimensional, simultaneous linear equation storage region 142; an analysis condition storage region 143; a first matrix form equation storage region 144; an inverse matrix storage region 145; an addition vector storage region 146; a second matrix form equation storage region 147; a third matrix form equation storage region 148; and a second inverse matrix storage region 149.

According to the present embodiment, for example, in three-dimensional irregular analysis, a solution of a simultaneous linear equation can be obtained at a high speed by a computer in certain procedure merely by setting analysis conditions such as initial conditions, boundary conditions, time step width, time step number, space step width, space step number, and solid state property values, and required division number.

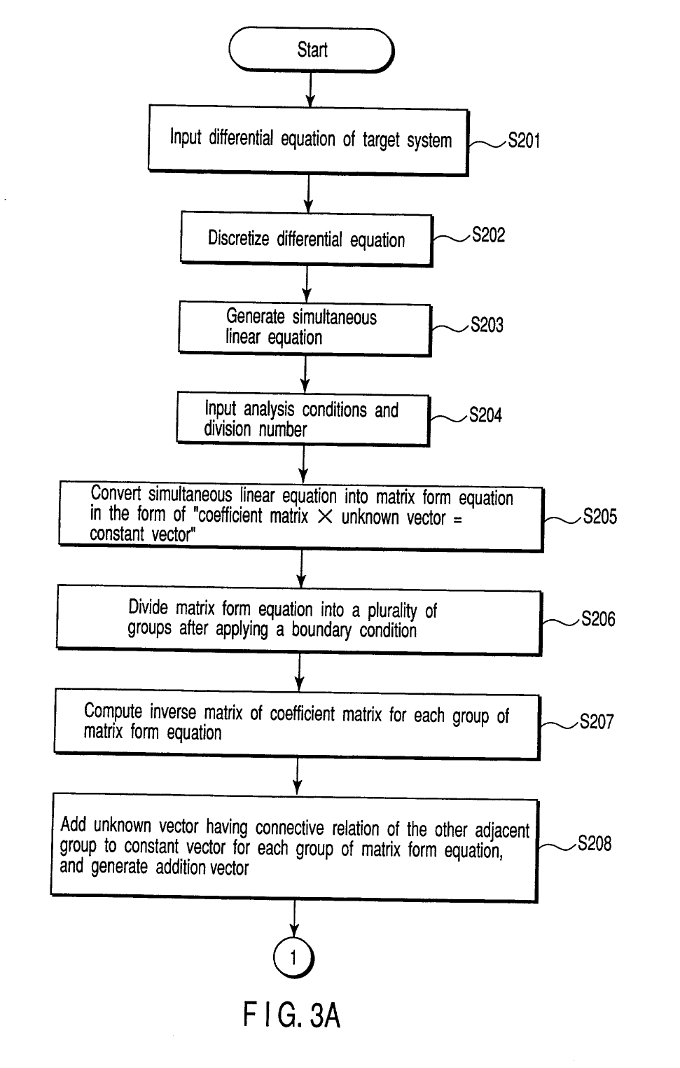

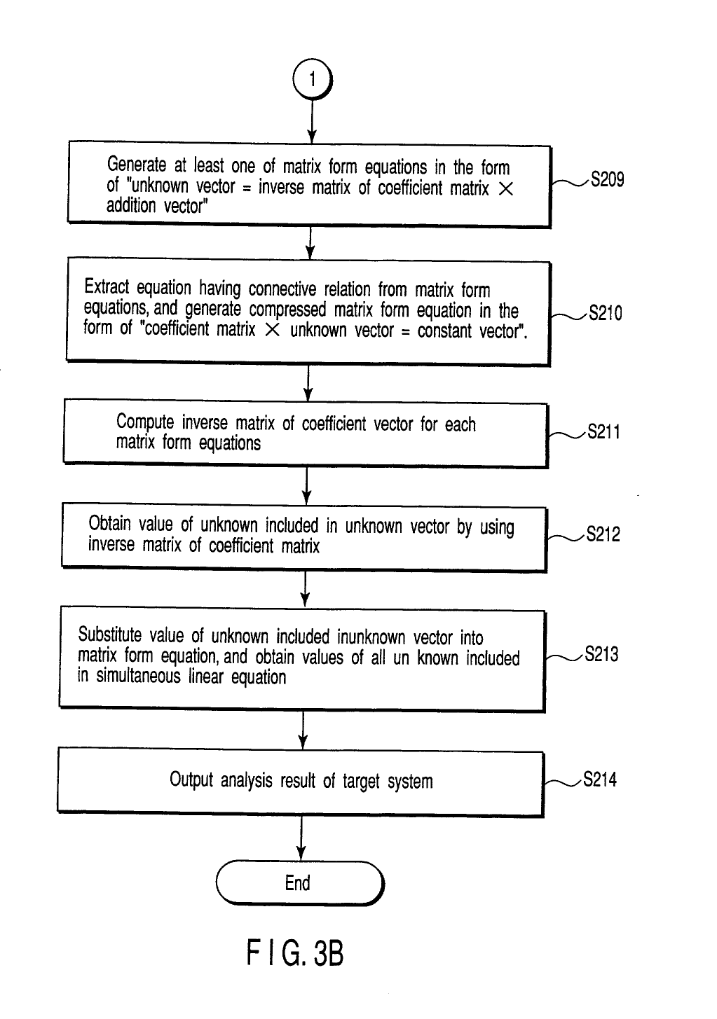

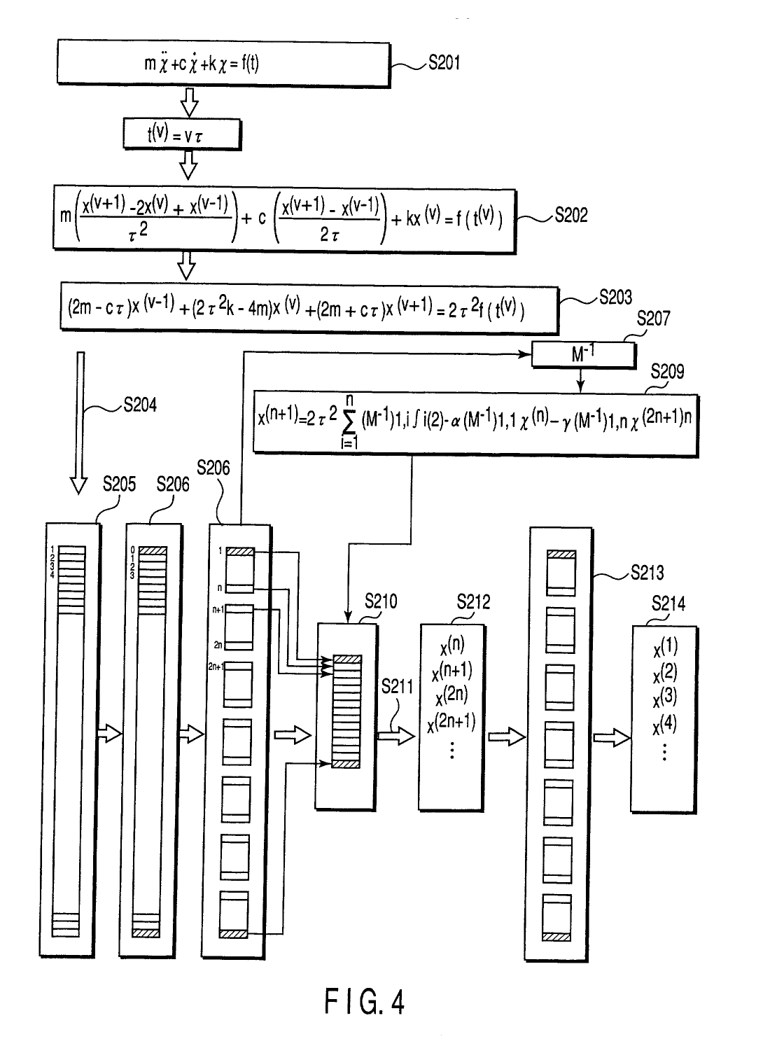

The present embodiment will be described by way of example of carrying out vibration analysis of the target system 10 when the target system 10 is a one-particle system. Operating procedure for such vibration analysis is shown in FIG. 3A and FIG. 3B. For clarity, FIG. 4 visually illustrates the operating procedure.

First, a differential equation simulating a physical phenomenon of the target system 10 is inputted (step S201). The differential equation is generally produced by the operator, and is inputted by the input device 14. The operator may produce a differential equation with the analysis software by inputting data required to produce the differential equation, for example, the kind of analysis such as vibration analysis, heat transmission analysis, or static stress analysis, solid state property value, shape and the like via the input device 14. Assuming a linear differential equation for an object receiving an external force, which exists in the target system 10, the following differential equation is inputted:

m\ddot{x}+c\dot{x}+kx=f(t) (1)

where

“m” is a mass;

“c” is a damping coefficient;

“k” is a spring constant;

“f(t)” is an external force; and

“x” is a change of an object.

The inputted differential equation is stored in the storage region 141 of the subsidiary memory 140. The CPU 120 read the differential equation from the storage region 141 of the subsidiary memory 140, and discretizes the differential equation by using a generally available finite element technique, finite differential technique or the like (step S202). For example, when the differential equation shown in equation (1) is inputted, time is defined as:

t^{(v)}=vτ (2)

Then, using a central difference as follows discretizes the differential equation:

$$m ( \frac{{x}^{( v + 1 )} - 2 {x}^{( v )} + {x}^{( v - 1 )}}{{τ}^{2}} ) + c ( \frac{{x}^{( v + 1 )} - {x}^{( v - 1 )}}{2 τ} ) + {kx}^{( v )} = f ( {t}^{( v )} ) \qquad ( 3 )$$

Next, the CPU 120 generates a multi-dimensional, simultaneous linear equation required for analysis of the target system 10 based on the differential equation (3), which has been discretized (step S203).

(2m−cτ)x^{(v-1)}+(2τ²k−4m)x^{(v)}+(2m+cτ)x^{(v+1)}=2τ²f(t^{(v)} (4)

Discretization of a differential equation and generation of a multi-dimensional, simultaneous linear equation are carried out by a computation program generally used conventionally. The thus generated multi-dimensional, simultaneous linear equation is established as an equation having a large number of unknowns. The generated multi-dimensional, simultaneous linear equation is stored in the multi-dimensional, simultaneous linear equation storage region 142 of the subsidiary memory 140.

Next, the operator inputs the analysis conditions such as initial conditions, boundary conditions, time step width, time step number, space step width, and space step number, and division number by the input device 14 (step S204). The inputted analysis conditions and division number are stored in the storage region 143 of the subsidiary memory 140.

Next, the CPU 120 read the generated multi-dimensional, simultaneous linear equation from the storage region 142 of the subsidiary memory 140, and generates a first matrix form equation shown below from the fetched multi-dimensional, simultaneous linear equation (step S205).

$$( \begin{matrix}α & β & γ 0 & 0 & 0 & 0 & & & & \\ & α & β & γ & 0 & 0 & 0 & 0 & & \\ & & α & β & γ & 0 & 0 & 0 & 0 & \\ & & & α & β & γ & 0 & 0 & 0 & 0 \\ & ⋯ & & & & & & & & \\ & & & & & & & & α & β \\ & & & & & & & & & α\end{matrix} ) ( \begin{matrix}{x}^{( 0 )} \\ {x}^{( 1 )} \\ {x}^{( 2 )} \\ {x}^{( 3 )} \\ ⋮ \\ {x}^{( m \times n - 1 )} \\ {x}^{( m \times n )}\end{matrix} ) = 2 {τ}^{2} ( \begin{matrix}f ( {t}^{( 1 )} ) \\ f ( {t}^{( 2 )} ) \\ f ( {t}^{( 3 )} ) \\ f ( {t}^{( 4 )} ) \\ ⋮ \\ f ( {t}^{( m \times n )} ) \\ f ( {t}^{( m \times n + 1 )}\end{matrix} ) - ( \begin{matrix}0 \\ 0 \\ 0 \\ 0 \\ ⋮ \\ γ {x}^{( m \times n + 1 )} \\ β {x}^{( m \times n + 1 )} + γ {x}^{( m \times n + 2 )}\end{matrix} ) \qquad ( 5 )$$

whre

α=(2m−cτ)

β=(2τ²k−4m)

λ=(2m+cτ)

In the present specification, an equation expressed by using a matrix is called a matrix form equation. A first matrix form equation of equation (5) is expressed in the form of “first coefficient matrix×first unknown vector=first constant vector”. Here, the first coefficient matrix is provided as a matrix consisting of only coefficients multiplied by unknowns included in the multi-dimensional, simultaneous linear equation. In equation (5), the equation is expressed by α, β, γ, 0. The first unknown vector is provided as a vector consisting of only unknowns included in the multi-dimensional, simultaneous linear equation. In equation (5), the vector is expressed by ×⁽⁰⁾, . . . , ×^{(m×n)}. The first constant vector is provided as a vector consisting of only constants included in the multi-dimensional, simultaneous linear equation. In equation (5), a vector at the right side of equal sign is provided.

The CPU 120 read analysis conditions inputted from the input device 14 by the operator from the storage region 143 of the subsidiary memory 14. This CPU divides the first matrix form equation into a plurality of groups in accordance with the analysis conditions (step S206). For example, as the boundary conditions included in the analysis conditions, x⁽⁰⁾ at an initial time and x^{(m×n+1)} at another time are defined as being known. At this time, when the boundary conditions are applied to the first matrix form equation shown in equation (5), the first matrix form equation is transformed in the following matrix form equation having a coefficient matrix of (m×n) lines and (m×n) columns.

$$( \begin{matrix}α & β & γ 0 & 0 & 0 & 0 & & & & \\ & α & β & γ & 0 & 0 & 0 & 0 & & \\ & & α & β & γ & 0 & 0 & 0 & 0 & \\ & & & α & β & γ & 0 & 0 & 0 & 0 \\ & ⋯ & & & & & & & & \\ & & & & & & & & α & β \\ & & & & & & & & & α\end{matrix} ) ( \begin{matrix}{x}^{( 0 )} \\ {x}^{( 1 )} \\ {x}^{( 2 )} \\ {x}^{( 3 )} \\ ⋮ \\ {x}^{( m \times n - 1 )} \\ {x}^{( m \times n )}\end{matrix} ) = 2 {τ}^{2} ( \begin{matrix}f ( {t}^{( 1 )} ) \\ f ( {t}^{( 2 )} ) \\ f ( {t}^{( 3 )} ) \\ f ( {t}^{( 4 )} ) \\ ⋮ \\ f ( {t}^{( m \times n )} ) \\ f ( {t}^{( m \times n + 1 )} )\end{matrix} ) - ( \begin{matrix}{ax}^{( 0 )} \\ 0 \\ 0 \\ 0 \\ ⋮ \\ 0 \\ γ {x}^{( m \times n + 1 )}\end{matrix} ) \qquad ( 6 )$$

Next, the CPU 120 read a division number (referred to as “m”) inputted from the input device 14 by the operator from the storage region 143 of the subsidiary memory 140. In the accordance with the division number, this CPU divides the first matrix form equation transformed as in equation (6) into “m” groups, each of which has a size of “n” lines×“n” columns, as shown below (step S206). These groups each are stored in the storage region 144 of the subsidiary memory 140. In this example, although the first matrix form equation has been equally divided in consideration of processing efficiency, the equation may not be equally divided.

$$M ( \begin{matrix}{x}^{( 1 )} \\ {x}^{( 2 )} \\ {x}^{( 3 )} \\ ⋮ \\ {x}^{( n )}\end{matrix} ) = 2 {τ}^{2} ( \begin{matrix}f ( {t}^{( 1 )} ) \\ f ( {t}^{( 2 )} ) \\ f ( {t}^{( 3 )} ) \\ ⋮ \\ f ( {t}^{( n )} )\end{matrix} ) + ( \begin{matrix}- {ax}^{( 0 )} \\ 0 \\ ⋮ \\ - γ {x}^{( n + 1 )}\end{matrix} ) \\ M ( \begin{matrix}{x}^{( n + 1 )} \\ {x}^{( n + 2 )} \\ {x}^{( n + 3 )} \\ ⋮ \\ {x}^{( 2 n )}\end{matrix} ) = 2 {τ}^{2} ( \begin{matrix}f ( {t}^{( n + 1 )} ) \\ f ( {t}^{( n + 2 )} ) \\ f ( {t}^{( n + 3 )} ) \\ ⋮ \\ f ( {t}^{( 2 n )} )\end{matrix} ) + ( \begin{matrix}- {ax}^{( n )} \\ 0 \\ ⋮ \\ - γ {x}^{( 2 n + 1 )}\end{matrix} ) \\ ⋮ \\ ⋮ \\ ⋮ \\ M ( \begin{matrix}{x}^{( m \times n - n + 1 )} \\ {x}^{( m \times n - n + 2 )} \\ {x}^{( m \times n - n + 3 )} \\ ⋮ \\ {x}^{( m \times n )}\end{matrix} ) = 2 {τ}^{2} ( \begin{matrix}f ( {t}^{( m \times n - n + 1 )} ) \\ f ( {t}^{( m \times n - n + 2 )} ) \\ f ( {t}^{( m \times n - n + 3 )} ) \\ ⋮ \\ f ( {t}^{( m \times n )} )\end{matrix} ) + ( \begin{matrix}- {ax}^{( m \times n - n )} \\ 0 \\ ⋮ \\ - γ {x}^{( m \times n + 1 )}\end{matrix} ) \\ whre \\ M = ( \begin{matrix}β & γ & 0 & 0 & 0 & 0 & & & & & & & & \\ α & β & γ & 0 & 0 & 0 & 0 & & & & & & & \\ & α & β & γ & 0 & 0 & 0 & 0 & & & & & & \\ & & α & β & γ & 0 & 0 & 0 & 0 & & & & & \\ & & & & & ⋯ & & & & & & & & \\ & & & & & ⋯ & & & & & & & & \\ & & & & & & & & & α & β & γ & & \\ & & & & & & & & & & & & α & β\end{matrix} ) \qquad ( 7 )$$

The CPU 120 read each group of the first matrix form equation from the storage region 144 of the subsidiary memory 140. This CPU computes an inverse matrix M⁻¹ of a first coefficient matrix M for each group (step S207). The computed inverse matrix shown in equation (7) is stored in the storage region 145 of the subsidiary memory 140. The first matrix form equation is divided into a plurality of groups, whereby the size of the first coefficient matrix is reduced. Thus, an inverse matrix is easily obtained within a short time. When the first matrix form equation is equally divided, an inverse matrix of one first coefficient matrix may be obtained. Thus, a computation time is further reduced.

The CPU 120 read each group of the first matrix form equation from the storage region 144 of the subsidiary memory 140 again. This CPU extracts an adjacent line of the other adjacent group from such each group. Then, a first unknown vector in the extracted line is added to a first constant vector, and a first addition vector is generated (step S208). The first addition vector is a summation of two vectors located at the right side of each group shown in equation (7) for the first matrix form equation. The first addition vector is stored in the storage region 146 of the subsidiary memory 140.

Next, the CPU 120 read the unknown vector included in each group of the first matrix form equation from the storage region 144 of the subsidiary memory 140, read the inverse matrix of the first coefficient matrix from the storage region 145, and read the first addition vector from the storage region 146. Then, the CPU generates a second matrix form equation of a plurality of groups in the form of “first unknown vector=inverse matrix of first coefficient matrix×first addition vector” (step S209). The produced second matrix form equation of a plurality of groups is stored in the storage region 147 of the subsidiary memory 140.

Next, the CPU 120 read the second matrix form equations from the storage region 147 of the subsidiary memory 140. Then, a line adjacent to the adjacent equation is extracted from fetched second matrix form equations, a compressed simultaneous equation is produced, and a further compressed third matrix form equation is produced (step S210). In the simultaneous equation, the equation is compressed only by collecting the top line and bottom line of second matrix form equations. For example, in extracting only a line adjacent to the adjacent equation of the second matrix form equations shown in equation (7), the following (2m−2) simultaneous equations are obtained.

$${x}^{( n )} = 2 {τ}^{2} {\sum }_{i = 1}^{n} {( {M}^{- 1} )}_{n , i} {f}_{i} ( 1 ) - {a ( {M}^{- 1} )}_{n , 1} {x}^{( 0 )} - {γ ( {M}^{- 1} )}_{n , n} {x}^{( n + 1 )} \\ {x}^{( n + 1 )} = 2 {τ}^{2} {\sum }_{i = 1}^{n} {( {M}^{- 1} )}_{1 , i} {f}_{i} ( 2 ) - {a ( {M}^{- 1} )}_{1 , 1} {x}^{( n )} - {γ ( {M}^{- 1} )}_{1 , n} {x}^{( 2 n + 1 )} \\ {x}^{( 2 n )} = 2 {τ}^{2} {\sum }_{i = 1}^{n} {( {M}^{- 1} )}_{n , i} {f}_{i} ( 2 ) - {a ( {M}^{- 1} )}_{n , 1} {x}^{( n )} - {γ ( {M}^{- 1} )}_{n , n} {x}^{( 2 n + 1 )} \\ {x}^{( 2 n + 1 )} = 2 {τ}^{2} {\sum }_{i = 1}^{n} {( {M}^{- 1} )}_{1 , i} {f}_{i} ( 3 ) - {a ( {M}^{- 1} )}_{1 , 1} {x}^{( 2 n )} - {γ ( {M}^{- 1} )}_{1 , n} {x}^{( 3 n + 1 )} \\ ⋮ \\ ⋮ \\ {x}^{( m \times n - n + 1 )} = 2 {τ}^{2} {\sum }_{i = 1}^{n} {( {M}^{- 1} )}_{1 , i} {f}_{i} ( m ) - {a ( {M}^{- 1} )}_{1 , 1} {x}^{( m \times n - n )} - {γ ( {M}^{- 1} )}_{1 , n} {x}^{( m \times n + 1 )} \\ where \\ \vec{f ( i )} = ( \begin{matrix}f ( {t}^{( i \times n - n + 1 )} ) \\ f ( {t}^{( i \times n - n + 2} ) \\ f ( {t}^{( i \times n - n + 3} ) \\ ⋮ \\ f ( {t}^{( i \times n )} )\end{matrix} ) , {f}_{j} ( i ) = f ( {t}^{( i \times n - n + j )} ) \qquad ( 8 )$$

This simultaneous equation is converted into a third matrix form equation in the form of “second coefficient matrix×second unknown vector=second constant vector”. The thus generated third matrix form equation is stored in the storage region 148 of the subsidiary memory 140.

Next, the CPU 120 read the third matrix form equation from the storage region 148 of the subsidiary memory 140, and computes an inverse matrix of the second coefficient matrix included in the third matrix form equation (step S211). The computed inverse matrix of the second coefficient matrix is stored in the storage region 149 of the subsidiary memory 140.

Next, the CPU 120 read the third matrix form equation and the inverse matrix of the second coefficient matrix from the storage regions 148 and 149 of the subsidiary memory 140. Then, this CPU obtains the value of each second unknown included in the unknown vector in the third matrix form equation (step S212). In this manner, all the unknowns included in the third matrix form equation, i.e., all the unknowns in a line adjacent to the adjacent equation of the second matrix form equation are obtained. In a (2m−2) dimensional, simultaneous linear equation, the number of unknowns is (2m−2). Thus, the unknowns x⁽ⁿ⁾, x⁽ⁿ⁺¹⁾, x⁽²ⁿ⁾, x⁽²ⁿ⁺¹⁾, x^{(n×m-n+1)} are obtained in accordance with the step S212.

Next, the CPU 120 read the second matrix form equation from the storage region 147 of the subsidiary memory 140. Then, this CPU substitutes the value of the unknown obtained in the step S212 into an addition vector of the second matrix form equation. In this manner, all the unknowns x (i) of the multi-dimensional, simultaneous linear equation shown in equation (4) are obtained (step S213).

In order to further deepen an understanding in the present embodiment, procedure for obtaining a value of an unknown from a specific simultaneous linear equation will be described.

### EXAMPLE 1

First, an inputted differential equation is discretized, whereby a simultaneous, linear equation having nine unknowns shown below is assumed to have been given. The inputted boundary conditions are x₀=1, x₁₀=0, and the division number is 2.

−x₀+1.99x₁−x₂=1

−x₁+1.99x₂−x₃=0

−x₂+1.99x₃−x₄=0

−x₃+1.99x₄−x₅=0

−x₄+1.99x₅−x₆=0 (9)

−x₅+1.99x₆−x₇=0

−x₆+1.99x₇−x₈=0

−x₇+1.99x₈−x₉=0

−x₈+1.99x₉−x₁₀=0

This simultaneous linear equation is converted into a first matrix form equation in the form of “first coefficient matrix×first unknown vector=first constant vector.

$$( \begin{matrix}1.99 & - 1 & 0 & & & & & & \\ - 1 & 1.99 & - 1 & 0 & & & & & \\ 0 & - 1 & 1.99 & - 1 & 0 & & & & \\ 0 & 0 & - 1 & 1.99 & - 1 & 0 & & & \\ 0 & 0 & 0 & - 1 & 1.99 & - 1 & 0 & & \\ 0 & 0 & 0 & 0 & - 1 & 1.99 & - 1 & 0 & \\ 0 & 0 & 0 & 0 & 0 & - 1 & 1.99 & - 1 & 0 \\ 0 & 0 & 0 & 0 & 0 & 0 & - 1 & 1.99 & - 1 \\ 0 & 0 & 0 & 0 & 0 & 0 & 0 & - 1 & 1.99\end{matrix} ) ( \begin{matrix}{x}_{1} \\ {x}_{2} \\ {x}_{3} \\ {x}_{4} \\ {x}_{5} \\ {x}_{6} \\ {x}_{7} \\ {x}_{8} \\ {x}_{9}\end{matrix} ) = ( \begin{matrix}1 \\ 0 \\ 0 \\ 0 \\ 0 \\ 0 \\ 0 \\ 0 \\ 0\end{matrix} ) \qquad ( 10 )$$

In equation (1), the matrix of the left side is a first coefficient matrix, the vector of the left side is a first unknown vector, and the vector of the right side is a first constant vector.

Next, the first matrix form equation is divided into a plurality of groups, for example, a first group of the top four lines and a second group of the bottom four lines.

$$\begin{matrix}( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{1} \\ {x}_{2} \\ {x}_{3} \\ {x}_{4}\end{matrix} ) = ( \begin{matrix}1 \\ 0 \\ 0 \\ 0\end{matrix} ) & ( \text{11-1} ) \\ ( \begin{matrix}1.99 & - 1 & 0 & & \\ - 1 & 1.99 & - 1 & 0 & \\ 0 & - 1 & 1.99 & - 1 & 0 \\ 0 & 0 & - 1 & 1.99 & - 1 \\ 0 & 0 & 0 & - 1 & 1.99\end{matrix} ) ( \begin{matrix}{x}_{5} \\ {x}_{6} \\ {x}_{7} \\ {x}_{8} \\ {x}_{9}\end{matrix} ) = ( \begin{matrix}0 \\ 0 \\ 0 \\ 0 \\ 0\end{matrix} ) & ( \text{11-2} )\end{matrix}$$

For groups of these first matrix form equations each, the unknown vector in a line adjacent to the other adjacent group is added to the constant vector, and the first addition vector of the following equation is generated.

$$\begin{matrix}( \begin{matrix}1 \\ 0 \\ 0 \\ 0\end{matrix} ) + ( \begin{matrix}0 \\ 0 \\ 0 \\ {x}_{5}\end{matrix} ) & ( \text{12-1} ) \\ ( \begin{matrix}0 \\ 0 \\ 0 \\ 0 \\ 0\end{matrix} ) + ( \begin{matrix}{x}_{4} \\ 0 \\ 0 \\ 0 \\ 0\end{matrix} ) & ( \text{12-2} )\end{matrix}$$

In the addition vector shown in equation (12-1), an unknown x⁵ in the top line of the second group shown in equation (11-2) adjacent to the first group is added to the constant vector of the first group shown in equation (11-1). In the addition vector shown in equation (12-2), an unknown x⁴ in the bottom line of the first group shown in equation (11-1) adjacent to the first group is added to the constant vector of the second group shown in equation (11-1).

When the constant vector of the first group shown in equation (11-1) is replaced with the addition vector shown in equation (12-1), and the constant vector of the second group shown in equation (11-2) is replaced with the addition vector shown in equation (12-2), the first and second groups of the first matrix form equation are transformed as follows.

$$\begin{matrix}( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{1} \\ {x}_{2} \\ {x}_{3} \\ {x}_{4}\end{matrix} ) = ( \begin{matrix}1 \\ 0 \\ 0 \\ 0\end{matrix} ) + ( \begin{matrix}0 \\ 0 \\ 0 \\ {x}_{5}\end{matrix} ) & ( \text{13-1} ) \\ ( \begin{matrix}1.99 & - 1 & 0 & & \\ - 1 & 1.99 & - 1 & 0 & \\ 0 & - 1 & 1.99 & - 1 & 0 \\ 0 & 0 & - 1 & 1.99 & - 1 \\ 0 & 0 & 0 & - 1 & 1.99\end{matrix} ) ( \begin{matrix}{x}_{5} \\ {x}_{6} \\ {x}_{7} \\ {x}_{8} \\ {x}_{9}\end{matrix} ) = ( \begin{matrix}0 \\ 0 \\ 0 \\ 0 \\ 0\end{matrix} ) + ( \begin{matrix}{x}_{4} \\ 0 \\ 0 \\ 0 \\ 0\end{matrix} ) & ( \text{13-2} )\end{matrix}$$

Next, the inverse matrix of the first coefficient matrix included in each group of the first matrix form equation is established as follows.

$$\begin{matrix}{( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} )}^{- 1} = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) & ( \text{14-1} ) \\ {( \begin{matrix}1.99 & - 1 & 0 & & \\ - 1 & 1.99 & - 1 & 0 & \\ 0 & - 1 & 1.99 & - 1 & 0 \\ 0 & 0 & - 1 & 1.99 & - 1 \\ 0 & 0 & 0 & - 1 & 1.99\end{matrix} )}^{- 1} = ( \begin{matrix}0.849092 & 0.689692 & 0.523396 & 0.351866 & 0.176817 \\ 0.689692 & 1.37249 & 1.04156 & 0.700213 & 0.351866 \\ 0.523396 & 1.04156 & 1.5493 & 1.04156 & 0.523396 \\ 0.351866 & 0.700213 & 1.04156 & 1.37249 & 0.689692 \\ 0.176817` & 0.351866 & 0.523396 & 0.689692 & 0.849092\end{matrix} ) & ( \text{14-2} )\end{matrix}$$

Next, corresponding to the respective first and second groups of the first matrix form equation, the second matrix form equations in the form of “first unknown vector=inverse matrix of first coefficient matrix×first addition vector” are generated as follows.

$$\begin{matrix}( \begin{matrix}{x}_{1} \\ {x}_{2} \\ {x}_{3} \\ {x}_{4}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}1 \\ 0 \\ 0 \\ {x}_{5}\end{matrix} ) & ( 15 - 1 ) \\ ( \begin{matrix}{x}_{5} \\ {x}_{6} \\ {x}_{7} \\ {x}_{8} \\ {x}_{9}\end{matrix} ) = ( \begin{matrix}0.849092 & 0.689692 & 0.523396 & 0.351866 & 0.176817 \\ 0.689692 & 1.37249 & 1.04156 & 0.700213 & 0.351866 \\ 0.523396 & 1.04156 & 1.5493 & 1.04156 & 0.523396 \\ 0.351866 & 0.700213 & 1.04156 & 1.37249 & 0.689692 \\ 0.176817 & 0.351866 & 0.523396 & 0.689692 & 0.849092\end{matrix} ) ( \begin{matrix}{x}_{4} \\ 0 \\ 0 \\ 0 \\ 0\end{matrix} ) & ( 15 - 2 )\end{matrix}$$

Next, a line adjacent to the other adjacent group is extracted from the second matrix form equations, thereby generating the third matrix form equation in the form of “second coefficient matrix×second unknown vector=second constant vector”. Specifically, the bottom line of equation (15-1) and the top line of equation (15-2) are first extracted. Then, the next simultaneous linear equation is generated.

x₄−0.812271x₃=0.208243

x₅−0.849092x₄=0 (16)

The simultaneous linear equation shown in equation (16) is converted into the form of “second coefficient matrix×second unknown vector=second constant vector” as follows, thereby obtaining a third matrix form equation.

$$( \begin{matrix}1 & - 0.812271 \\ - 0.849092 & 1\end{matrix} ) ( \begin{matrix}{x}_{4} \\ {x}_{5}\end{matrix} ) = ( \begin{matrix}0.208243 \\ 0\end{matrix} ) \qquad ( 17 )$$

Next, an inverse matrix of the second coefficient matrix in the third matrix form equation is computed as follows.

$$( \begin{matrix}1 & - 0.812271 \\ - 0.849092 & 1\end{matrix} ) = ( \begin{matrix}3.22261 & 2.61763 \\ 2.73629 & 3.22261\end{matrix} ) \qquad ( 18 )$$

From this inverse equation and the second constant vector, the values of unknowns x₄ and x₅ included in the second unknown vector are obtained in accordance with the matrix form equation shown below.

$$( \begin{matrix}{x}_{4} \\ {x}_{5}\end{matrix} ) = ( \begin{matrix}3.22261 & 2.61763 \\ 2.73629 & 3.22261\end{matrix} ) ( \begin{matrix}0.208243 \\ 0\end{matrix} ) = ( \begin{matrix}0.671084 \\ 0.569812\end{matrix} ) \qquad ( 19 )$$

When the thus obtained value of the unknown x₅ is substituted into the second matrix form equation shown in equation (15-1), and the value of unknown x₄ is substituted into the second matrix form equation shown in equation (15-2), two matrix form equations shown below are obtained.

$$\begin{matrix}( \begin{matrix}{x}_{1} \\ {x}_{2} \\ {x}_{3} \\ {x}_{4}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}1 \\ 0 \\ 0 \\ 0.569812\end{matrix} ) & ( 20 - 1 ) \\ ( \begin{matrix}{x}_{5} \\ {x}_{6} \\ {x}_{7} \\ {x}_{8} \\ {x}_{9}\end{matrix} ) = ( \begin{matrix}0.849092 & 0.689692 & 0.523396 & 0.351866 & 0.176817 \\ 0.689692 & 1.37249 & 1.04156 & 0.700213 & 0.351866 \\ 0.523396 & 1.04156 & 1.5493 & 1.04156 & 0.523396 \\ 0.351866 & 0.700213 & 1.04156 & 1.37249 & 0.689692 \\ 0.176817 & 0.351866 & 0.523396 & 0.689692 & 0.849092\end{matrix} ) ( \begin{matrix}0.671084 \\ 0 \\ 0 \\ 0 \\ 0\end{matrix} ) & ( 20 - 2 )\end{matrix}$$

From these matrix form equations, all of the nine unknowns of the simultaneous linear equation shown in equation (9) are obtained.

### EXAMPLE 2

Procedure for solving a simultaneous linear equation shown in equation (9) with a division number being 3 will be described. First, in three first matrix form equations obtained by equally dividing the simultaneous linear equation into three sections, the vector of the boundary section (adjacent line) in the unknown vector of the adjacent group is added to the constant vector of the first matrix form equation in each group. As a result, the obtained matrix form equation is as follows. The addition vector is a summation of two vectors at the right side of “=” of the following matrix form equation.

$$\begin{matrix}( \begin{matrix}1.99 & - 1 & 0 \\ - 1 & 1.99 & - 1 \\ 0 & - 1 & 1.99\end{matrix} ) ( \begin{matrix}{x}_{1} \\ {x}_{2} \\ {x}_{3}\end{matrix} ) = ( \begin{matrix}1 \\ 0 \\ 0\end{matrix} ) + ( \begin{matrix}0 \\ 0 \\ {x}_{4}\end{matrix} ) \\ ( \begin{matrix}1.99 & - 1 & 0 \\ - 1 & 1.99 & - 1 \\ 0 & - 1 & 1.99\end{matrix} ) ( \begin{matrix}{x}_{4} \\ {x}_{5} \\ {x}_{6}\end{matrix} ) = ( \begin{matrix}0 \\ 0 \\ 0\end{matrix} ) + ( \begin{matrix}{x}_{3} \\ 0 \\ {x}_{7}\end{matrix} ) \\ ( \begin{matrix}1.99 & - 1 & 0 \\ - 1 & 1.99 & - 1 \\ 0 & - 1 & 1.99\end{matrix} ) ( \begin{matrix}{x}_{7} \\ {x}_{8} \\ {x}_{9}\end{matrix} ) = ( \begin{matrix}0 \\ 0 \\ 0\end{matrix} ) + ( \begin{matrix}{x}_{6} \\ 0 \\ 0\end{matrix} )\end{matrix} \qquad ( 21 )$$

Then, an inverse matrix of the coefficient matrix of each group in the first matrix form equation is computed for each group as in the following equation. In this case, the coefficient matrixes are the same as each other, and thus, an inverse matrix of the coefficient matrix of one group may be obtained.

$${( \begin{matrix}1.99 & - 1 & 0 \\ - 1 & 1.99 & - 1 \\ 0 & - 1 & 1.99\end{matrix} )}^{- 1} = ( \begin{matrix}0.758883 & 0.510178 & 0.256371 \\ 0.510178 & 1.01525 & 0.510178 \\ 0.256371 & 0.510178 & 0.758883\end{matrix} ) \qquad ( 22 )$$

From the computed inverse matrix, a second matrix form equation expressed as “unknown vector=inverse matrix×addition vector” is generated. The generated second matrix form equations are established as the following matrix form equation.

$$\begin{matrix}( \begin{matrix}{x}_{1} \\ {x}_{2} \\ {x}_{3}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}1 \\ 0 \\ {x}_{4}\end{matrix} ) \\ \begin{matrix}( \begin{matrix}{x}_{4} \\ {x}_{5} \\ {x}_{6}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}{x}_{3} \\ 0 \\ {x}_{7}\end{matrix} ) \\ ( \begin{matrix}{x}_{7} \\ {x}_{8} \\ {x}_{9}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}{x}_{6} \\ 0 \\ 0\end{matrix} )\end{matrix}\end{matrix} \qquad ( 23 )$$

Next, only the equation located at the boundary section between equations is fetched in accordance with this second matrix form equation, and the following simultaneous equation is generated.

x₃=0.256371+0.758883x₄

x₄=0.758883x₃+0.256371x₇

x₆=0.256371x₃+0.758883x₇ (24)

x₇=0.758883x₆

When a matrix form equation is generated from this simultaneous linear equation, the generated matrix form equation is established as the following third matrix expressed in the from of “coefficient matrix×unknown vector=constant vector”.

$$( \begin{matrix}1 & - 0.758883 & 0 & 0 \\ - 0.758883 & 1 & 0 & - 0.256371 \\ - 0.256371 & 0 & 1 & - 0.758883 \\ 0 & 0 & - 0.758883 & 1\end{matrix} ) ( \begin{matrix}{x}_{3} \\ {x}_{5} \\ {x}_{6} \\ {x}_{7}\end{matrix} ) = ( \begin{matrix}0.256371 \\ 0 \\ 0 \\ 0\end{matrix} ) \qquad ( 25 )$$

Then, an inverse matrix of the coefficient matrix in the third matrix form equation is computed. From this inverse matrix and the constant vector, the following matrix form equation is established to obtain the values of the unknowns x₃, x₄, x₆, and x₇.

$$( \begin{matrix}{x}_{3} \\ {x}_{4} \\ {x}_{6} \\ {x}_{7}\end{matrix} ) = ( \begin{matrix}2.98648 & 2.26639 & 1.03971 & 1.37006 \\ 2.61763 & 2.98648 & 1.37006 & 1.80536 \\ 1.80536 & 1.37006 & 2.98648 & 2.61763 \\ 1.37006 & 1.03971 & 2.26639 & 2.98648\end{matrix} ) ( \begin{matrix}0.256371 \\ 0 \\ 0 \\ 0\end{matrix} ) \qquad ( 26 )$$

From this matrix form equation, the values of the unknowns x₃, x₄, x₆, and x₇ are obtained as follows.

$$( \begin{matrix}{x}_{3} \\ {x}_{4} \\ {x}_{6} \\ {x}_{7}\end{matrix} ) = ( \begin{matrix}0.765646 \\ 0.671084 \\ 0.462842 \\ 0.351243\end{matrix} ) \qquad ( 27 )$$

The values of the unknowns x₃, x₄, x₆, and x₇ are substituted into the second matrix form equation shown in equations (23), and the following matrix form equations are established. Then, all of the nine unknowns of the simultaneous linear equation given from this matrix form equations are obtained.

$$( \begin{matrix}{x}_{1} \\ {x}_{2} \\ {x}_{3}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}1 \\ 0 \\ 0.671084\end{matrix} ) \\ ( \begin{matrix}{x}_{4} \\ {x}_{5} \\ {x}_{6}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}0.765646 \\ 0 \\ 0.351243\end{matrix} ) \\ ( \begin{matrix}{x}_{7} \\ {x}_{8} \\ {x}_{9}\end{matrix} ) = ( \begin{matrix}0.758883 & 0.510178 & 0.256371 \\ 0.510178 & 1.01525 & 0.510178 \\ 0.256371 & 0.510178 & 0.758883\end{matrix} ) ( \begin{matrix}0.462842 \\ 0 \\ 0\end{matrix} ) \qquad ( 28 )$$

As in the present embodiment, the matrix form equation obtained from the simultaneous linear equation is divided, and the matrix form equation obtained by fetching and compressing only the equation at the boundary section of the divided matrix form equation is generated. When this matrix form equation is solved, thereby finally obtaining all of the unknowns in the original matrix form equation, it is possible to establish a complicated simultaneous linear equation in accordance with very simple procedure, and moreover, in a business-like manner.

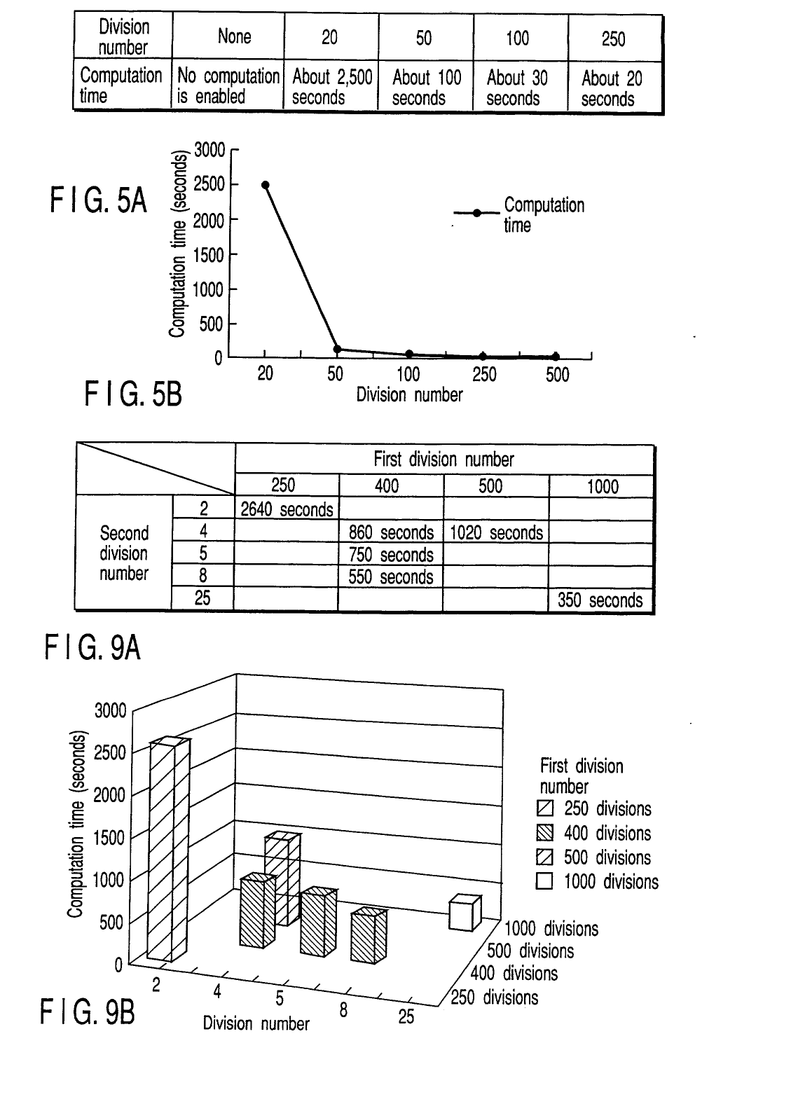

In actuality, when analytical computation is carried out in accordance with the present embodiment, a computation time can be significantly reduced as shown in FIG. 9. FIG. 5A and FIG. 5B show a result of measurement of a time required to solve 100,000-dimensional, simultaneous linear equation obtained when vibration response analysis of a one particle system, i.e., a matrix form equation having a coefficient matrix of 100,000 lines×100,000 columns. As shown in FIG. 5A, if an attempt is made to solve the matrix form equation in accordance with a conventional technique, a tremendously large amount of time is required for solving the equation. In accordance with the present embodiment, in the case of 20 divisions, the matrix form equation can be solved within 2,500 seconds. In the case of 50 divisions, the equation can be solved within 100 second. Further, in the case of 250 divisions, the equation can be solved within only 20 seconds. FIG. 5B graphically depicts a relationship between a division number and a computation time. It is found that a computation time decreases rapidly up to 50 divisions, and the computation time decreases gradually in the division numbers or more. From this result, about 100 division numbers will suffice practically relevant to the matrix form equation of the present embodiment.

As has been described above, according to the present embodiment, it is possible to solve even a simultaneous linear equation having a vary large number of unknowns within a short time. Therefore, analysis of a state of a physical target system such as a building vibration transmission state or a room temperature distribution state can be carried out with high precision.

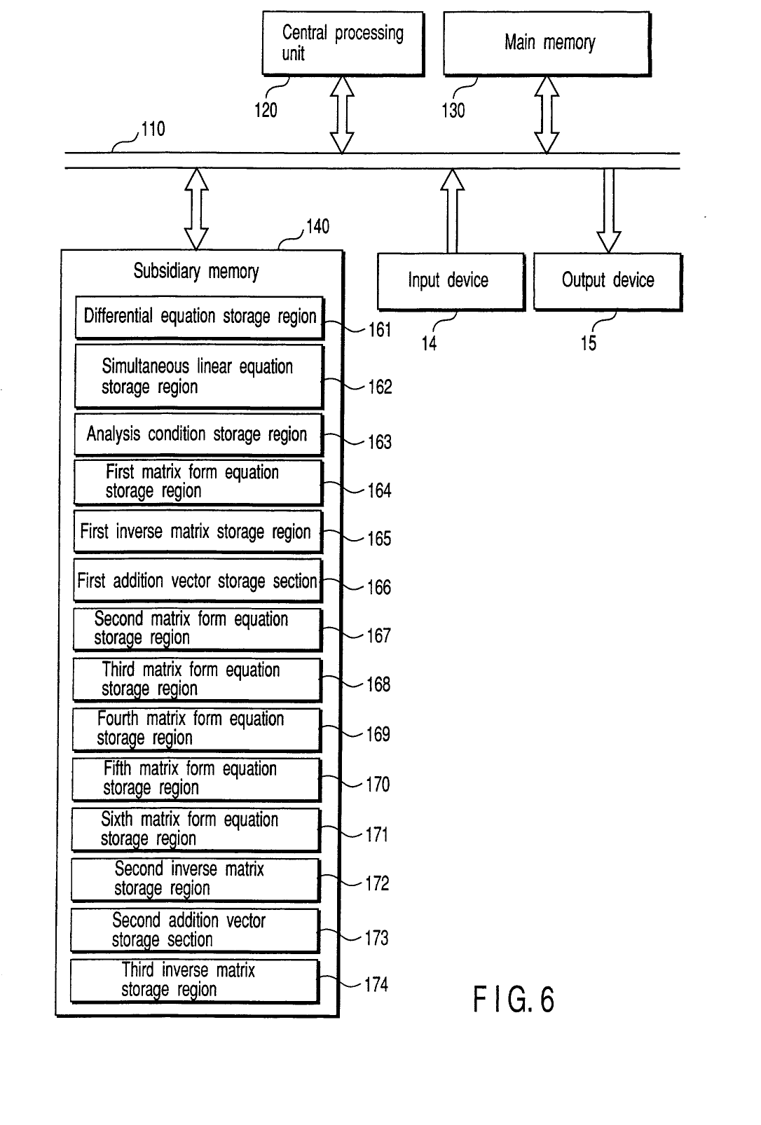

FIG. 6 shows another embodiment of a solver system 13 in FIG. 1. A subsidiary memory 160 is different from that shown in FIG. 2. That is, the subsidiary memory 160 is divided into: a differential equation storage region 161; a multi-dimensional, simultaneous linear equation storage region 162; an analysis condition storage region 163; a first matrix form equation storage region 164; a first inverse matrix storage region 165; a first addition vector storage region 166, a second matrix form equation storage region 167; a third matrix form equation storage region 168; a fourth matrix form storage region 169; a fifth matrix form equation storage region 170; a sixth matrix form equation storage region 171; a second inverse matrix storage region 172; a second addition vector storage region 173; and a third inverse matrix storage region 174.

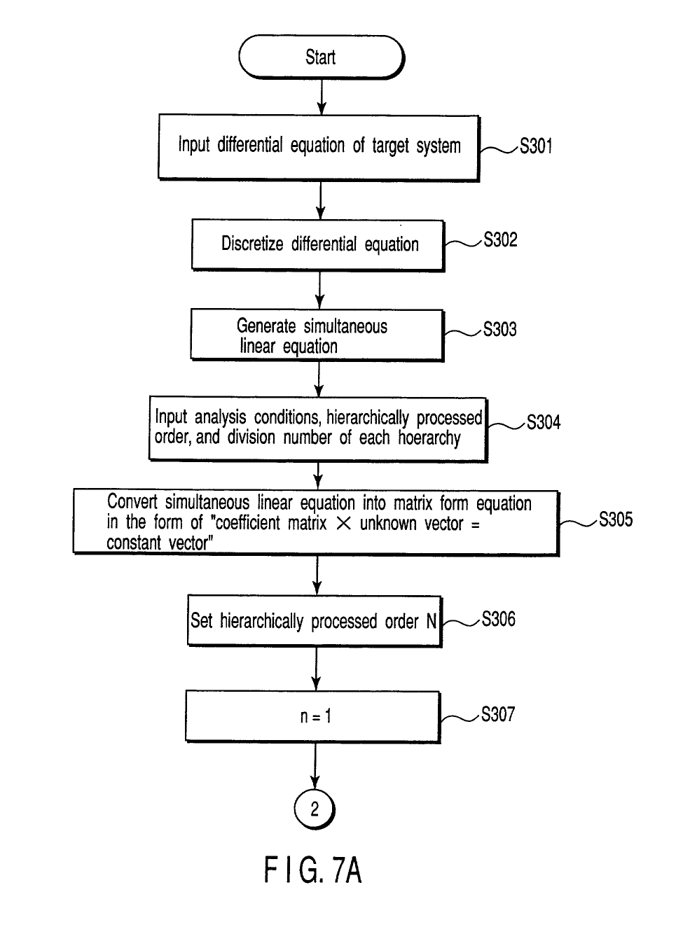

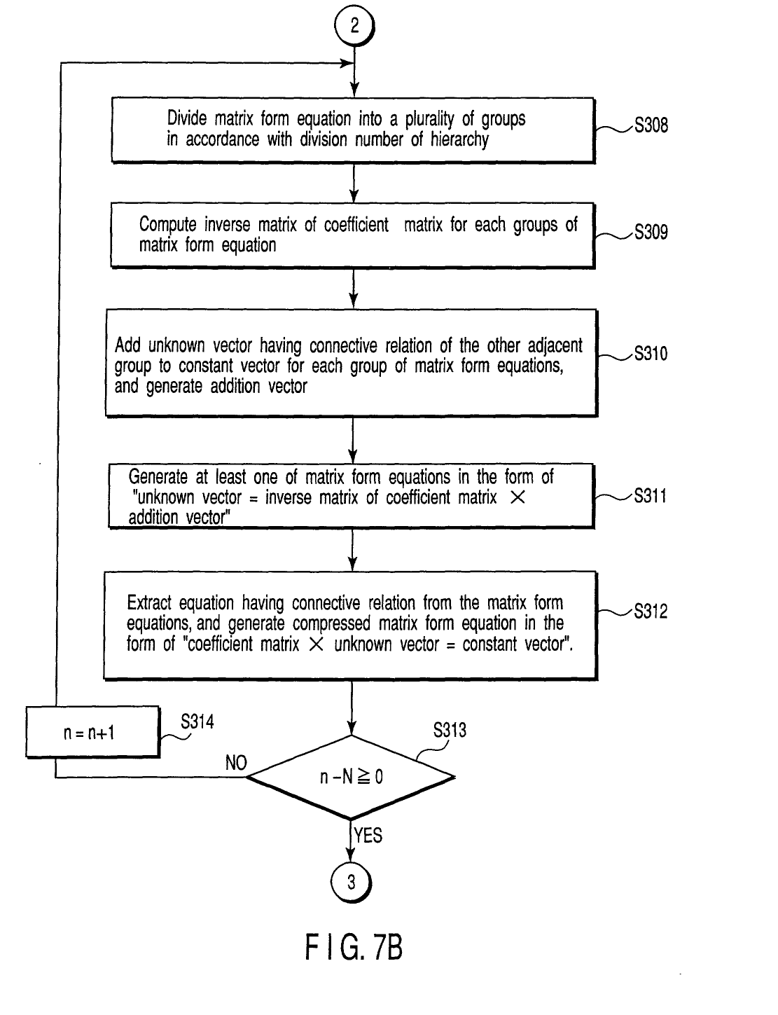

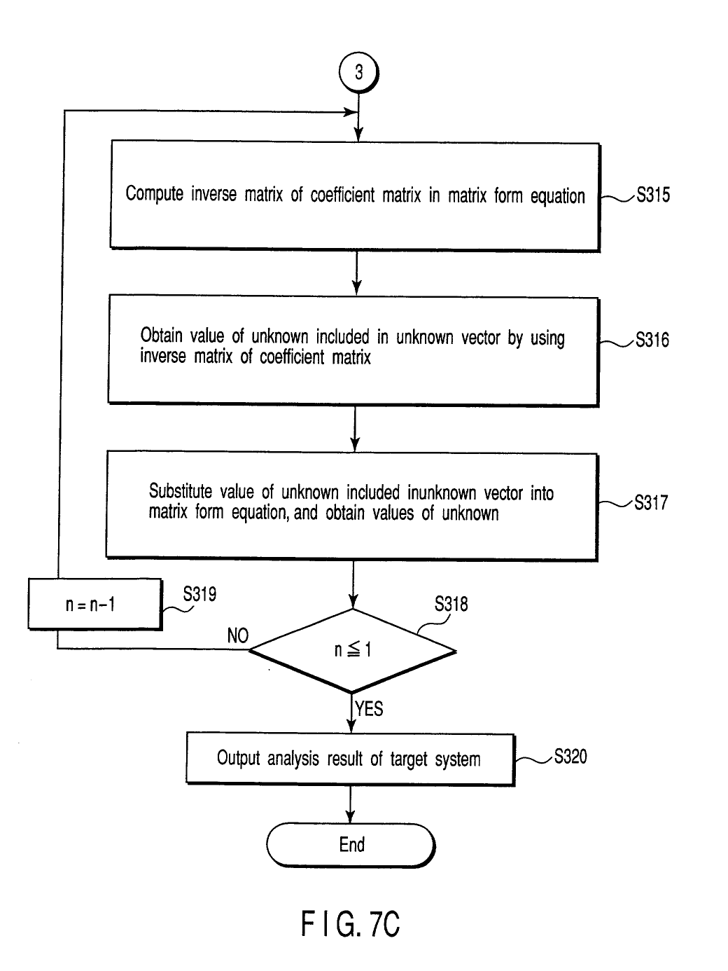

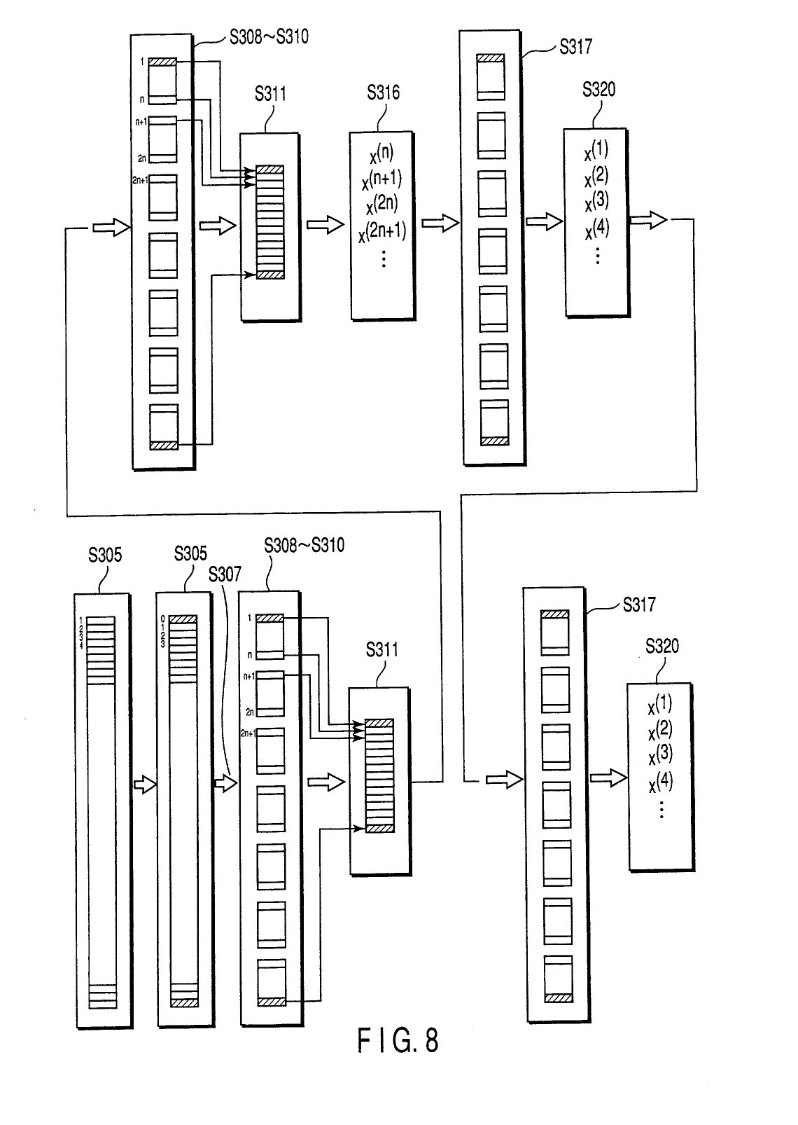

A case in which vibration analysis of the target system 10 is carried out when the target system 10 is a one-particle system, will be described by way of example. Operating procedure for vibration analysis is shown in FIG. 7A and FIG. 7B. FIG. 8 visually illustrates the operating procedure for clarity.

First, a differential equation simulating a physical phenomenon of the target system 10 is inputted (step S301). The differential equation is generally produced by the operator, and is inputted by the input device 14. The operator may produce a differential equation by the analysis software by inputting data required to produce the differential equation, for example, the kind of analysis such as vibration analysis, heat transmission analysis, or static stress analysis, physical value, shape and the like via the input device 14.

The inputted differential equation is stored in the storage region 161 of the subsidiary memory 160. The CPU 120 read the differential equation from the storage region 161 of the subsidiary memory 160, and discretizes the differential equation by using a generally available finite element technique, finite differential technique or the like (step S302).

Next, the CPU 120 generates a multi-dimensional, simultaneous linear equation required for analysis of the target system 10 based on the differential equation which has been discretized (step S303).

Discretization of a differential equation and generation of a multi-dimensional, simultaneous linear equation are carried out by a computation program generally used conventionally. The thus generated multi-dimensional, simultaneous linear equation is established as an equation having a large number of unknowns. The generated multi-dimensional, simultaneous linear equation is stored in the multi-dimensional, simultaneous linear equation storage region 162 of the subsidiary memory 160.

Next, the operator inputs the analysis conditions such as initial conditions, boundary conditions, time step width, time step number, space step width, and space step number, a hierarchically processed order N, and division number of each hierarchy, which are required for analysis, by the input device 14 (step S304). The hierarchically processed order is a count of repeating division and compression of a matrix form equation, and is set to, for example, 2 or more. The inputted analysis conditions, hierarchically processed orders N and division number of each hierarchy are stored in the storage region 163 of the subsidiary memory 160.

Next, the CPU 120 read the generated multiple simultaneous linear equation from the storage region 162 of a subsidiary memory 160, and the fetched multiple simultaneous linear equation is converted into the first matrix form equation (step S305). The first matrix form equation is expressed in the form of “first coefficient matrix×first unknown vector=first constant vector”.

The CPU 120 read analysis conditions such as boundary condition that the operator has inputted from the input device 14, hierarchically processed orders, and division number of each hierarchy from the storage region 163 of the subsidiary memory 160, and sets the hierarchically processed orders N (for example, N=2) (step S306). Further, the CPU sets a counter value “n” to n=1 as an initial value for hierarchical processing (step S307).

Next, the CPU 120 equally divides the matrix form equation generated in the step S305 into a plurality of groups each by the division number of a first hierarchy set in the step S306, thereby generating the first matrix form equation of the first hierarchy (step S308). For example, as the boundary conditions, when x ^{(m×n+1)} at an initial time x⁽⁰⁾ is known, the boundary conditions are applied to the matrix form equation generated in the step S305, and a matrix form equation having a coefficient matrix of (m×n) lines and (m×n) columns is generated. This matrix form equation is equally divided into n lines×n columns, whereby a matrix form equation divided into “m” groups each is generated. In this example, although the matrix form equation has been equally divided considering processing efficiency, the equation may not be equally divided. The matrix form equation divided into a plurality of groups each is stored in the storage region 164 of the subsidiary memory 160.

Next, the CPU 120 read the matrix form equation divided into “m” groups for each group from the storage region 164 of the subsidiary memory 160 and computes an inverse matrix of the coefficient matrix of the fetched matrix form equation (step S309). The obtained inverse matrix is stored in the storage region 165 of the subsidiary memory 160. Processing for obtaining this inverse matrix is continued until inverse matrixes of all the divided matrix form equations have been obtained. Therefore, the inverse matrix is obtained for each group by the number identical to the division number of the first hierarchy. The first matrix form equation is divided into a plurality of groups each, whereby the size of the first coefficient matrix is reduced. Thus, the inverse matrix can be easily obtained within a short time. When the first matrix form equation is equally divided, the inverse matrix of one first coefficient matrix may be obtained. Thus, the computation time is further reduced.

The CPU 120 read each group of the first matrix form equations from the storage region 164 of the subsidiary memory 160 again, and extracts a line of the other group adjacent thereto from such each group. Then, the CPU adds an unknown vector in the extracted line to a constant vector, and generates an addition vector (step S310). The addition vector is stored in the storage region 166 of the subsidiary memory 160.

The CPU 120 read the unknown vector included in the matrix form equation after divided from the storage region 164 of the subsidiary memory 160, read the inverse matrix from the storage region 165, and read the addition vector from the storage region 166. In this manner, the CPU generates second matrix form equations in the form of “unknown vector=inverse matrix×addition vector” for each group (step S311). The generated second matrix form equations are stored in the storage region 167 of the subsidiary memory 160.

Next, the CPU 120 read the second matrix form equations from the storage region 167 of the subsidiary memory 160. A line adjacent to the other equation is extracted from the fetched second matrix form equation, a compressed simultaneous equation is generated, and a further compressed matrix form equation is generated (step S312). In the simultaneous equation, only the top line and bottom line of each in the second matrix form equations are collected, whereby the equation is compressed. The simultaneous equation is converted into a third matrix form equation in the form of “coefficient matrix×unknown vector=constant vector”. The thus generated third matrix form equation is stored in the storage region 168 of the subsidiary memory 160.

Next, the CPU 120 read a value of the hierarchically processed order N from the storage region 163 of the subsidiary memory 160. Then, the CPU computes n−N from a value of the counter “n” that counts the value of N and the steps of hierarchical processing, and determines whether or not n−N≧0 (step S313). At this time, n=1 is established, and the count of repeating division/compression of a matrix form equation does not reach the set count. Thus, the CPU 120 read the division number of the second hierarchy from the storage region 163 of the subsidiary memory 160, and read the third matrix form equation from the storage region 168 of the subsidiary memory 160. Then, this condition is applied to the third matrix form equation, and is divided by its division number (step S308). In this manner, a fourth matrix form equation of the second hierarchy is generated, and is stored in the storage region 169 of the subsidiary memory 160. Then, the CPU 120 increments a value of the counter “n” by 1. Here, n=2 is established (S314).

Next, the CPU 120 read the third matrix form equation from the storage region 168 of the subsidiary memory 160, and computes an inverse matrix of the coefficient matrix included in this matrix form equation (step S309). The computed inverse matrix of the coefficient matrix is stored in the storage region 172 of the subsidiary memory 160. Processing for obtaining the above inverse matrix is continued until an inverse matrix of the coefficient matrix in all the divided matrix form equation has been obtained, in other words, until an inverse matrix of the coefficient matrix has been obtained for all the groups each. Therefore, the inverse matrix is obtained for each group in number equal to the division number of the second hierarchy. If the matrix is equally divided, the inverse matrix of one matrix may be obtained.

The CPU 120 read each group of the first matrix form equation from the storage region 164 of the subsidiary memory 160 again, and extracts a line of the other group adjacent thereto from such each group. Then, the CPU adds an unknown vector in the extracted line to a constant vector, and generates an addition vector (step S310). The addition vector is stored in the storage region 173 of the subsidiary memory 160.

The CPU 120 read the unknown vector included in the matrix form equation after divided from the storage region 164 of the subsidiary memory 160, read the inverse matrix from the storage region 165, and read the addition vector from the storage region 166. In this manner, the CPU generates fifth matrix form equations in the form of “unknown vector=inverse matrix×addition vector” for each group (step S311). The generated fifth matrix form equations are stored in the storage region 170 of the subsidiary memory 160.

Next, the CPU 120 read the fifth matrix form equations from the storage region 170 of the subsidiary memory 160. Then, the CPU extracts a line adjacent to the other equation of the acquired fifth matrix form equations, and generates a compressed sixth matrix form equation (step S312). The sixth matrix form equation is stored in the storage region 171 of the subsidiary memory 160.

Next, the CPU 120 read a value of the hierarchically processed order N from the storage region 163 of the subsidiary memory 160. Then, the CPU computes n−N from the value of the fetched hierarchically processed order N and a value of the counter “n” that counts the steps of hierarchical processing, and determines whether or not n−N≧0 (step S310). When n−N≧0 (at this time, n=2 is established), the count of repeating division/compression of the matrix form equation reaches 2 which is the set count. In order to obtain a solution of the compressed matrix form equation, the CPU 120 read the sixth matrix form equation from the storage region 171 of the subsidiary memory 160, and computes an inverse matrix of the coefficient matrix in the sixth matrix form equation (step S315). The obtained inverse matrix is stored in the storage region 174 of the subsidiary memory 160.

Next, the CPU 120 read a sixth matrix form equation from the storage region 171 of the subsidiary memory 160, and read an inverse matrix from the third inverse matrix storage region 174. In this manner, the CPU obtains the value of each unknown of an unknown vector in the sixth matrix form equation (step S316). Here, the unknown has been determined, whereby all the unknowns in the sixth matrix form equation are obtained. For example, as shown in the step S316 of FIG. 8, unknowns x^{(m×n)}, x^{(m×n+1)}, x^{(2×n)}, . . . are obtained.

As has been described above, when the unknowns at the boundary portion in the fifth matrix form equations each are obtained, the CPU 120 further read the fifth matrix form equations from the storage region 170 of the subsidiary memory 160. Then, the CPU substitutes the computed value of each unknown into the addition vector in the fifth matrix form equations. Then, the CPU computes all the unknowns in the fifth matrix form equations by utilizing the inverse matrix computed in the step S309 (step S317). For example, as shown in the step S317 of FIG. 8, all the unknowns x⁽¹⁾, x^{(m×n)}, x^{(m×n+1)}, located at the boundary portion of the fourth matrix form equation are obtained.

Next, the CPU 120 determines whether or not the value of the counter “n” that counts the steps of hierarchical processing is equal to or smaller than 1 (step S318). If n≦1 (at this time, n=2 is established), the CPU 120 decrements a value of the counter “n” that counts the steps of hierarchical processing, and set the value to 1 (step S319).

As has been described above, when the unknowns at the boundary portion of the fourth matrix form equations each are obtained, the CPU 120 further read the second matrix form equations from the storage region 167 of the subsidiary memory 160. Then, the CPU substitutes the computed value of each unknown into the addition vector of the second matrix form equations, and computes the values of all the unknowns in the simultaneous linear equation (step S317). For example, as shown in FIG. 8, x^{(m×n)} is obtained from the unknown x⁽¹⁾.

The CPU 120 determines whether or not the value of the counter “n” that counts the steps of hierarchical processing is equal to or smaller than 1. If n≦1 (at this time, n=1 is established), the CPU 120 terminates processing.

Next, in order to deepen understanding more, a description will be given with respect to procedure for obtaining a value of an unknown from the specific simultaneous linear equation by carrying out division/compression processing (hierarchically processed order N=2) twice.

First, assume that an inputted differential equation is discretized, whereby a simultaneous linear equation having the following 16 unknowns is given. The inputted boundary conditions are x₀=1, x₁₇=0. The inputted hierarchically processed order is 2, the division number of the first hierarchy is 4, and the division number of the second hierarchy is 2.

−x₀+1.99x₁−x₂=1

−x₁+1.99x₂−x₃=0

−x₂+1.99x₃−x₄=0

−x₃+1.99x₄−x₅=0

−x₄+1.99x₅−x₆=0

−x₅+1.99x₆−x₇=0

−x₆+1.99x₇−x₈=0

−x₁₄+1.99x₁₅−x₁₆=0

−x₁₅+1.99x₁₆−x₁₇=0 (29)

This simultaneous linear equation is converted into the first matrix form equation in the form of “first coefficient matrix×first unknown×first unknown vector first constant vector” as follows.

$$( \begin{matrix}1.99 & - 1 & 0 & & & & & & \\ - 1 & 1.99 & - 1 & 0 & & & & & \\ 0 & - 1 & 1.99 & - 1 & 0 & & & & \\ 0 & 0 & - 1 & 1.99 & - 1 & 0 & & & \\ 0 & 0 & 0 & - 1 & 1.99 & - 1 & 0 & & \\ ⋮ & ⋮ & ⋮ & ⋮ & ⋮ & ⋮ & ⋮ & ⋮ & ⋮ \\ ⋮ & ⋮ & ⋮ & ⋮ & ⋮ & ⋮ & ⋮ & ⋮ & ⋮ \\ & & & & & & - 1 & 1.99 & - 1 \\ & & & & & & 0 & - 1 & 1.99\end{matrix} ) ( \begin{matrix}{x}_{1} \\ {x}_{2} \\ {x}_{3} \\ {x}_{4} \\ {x}_{5} \\ ⋮ \\ ⋮ \\ {x}_{15} \\ {x}_{16}\end{matrix} ) = ( \begin{matrix}1 \\ 0 \\ 0 \\ 0 \\ 0 \\ ⋮ \\ ⋮ \\ 0 \\ 0\end{matrix} ) \qquad ( 30 )$$

In equation (30), the matrix of the right side is a first coefficient matrix, the vector of the left side is a first unknown vector, and the vector of the right side is a first constant vector.

Next, the first matrix form equation is divided into four groups each in accordance with the division number (=4) of the inputted first hierarchy. When the equation is simply divided into four groups, the following four groups are formed.

$$\begin{matrix}( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{1} \\ {x}_{2} \\ {x}_{3} \\ {x}_{4}\end{matrix} ) = ( \begin{matrix}1 \\ 0 \\ 0 \\ 0\end{matrix} ) & ( 31 - 1 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{5} \\ {x}_{6} \\ {x}_{7} \\ {x}_{8}\end{matrix} ) = ( \begin{matrix}0 \\ 0 \\ 0 \\ 0\end{matrix} ) & ( 31 - 2 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{9} \\ {x}_{10} \\ {x}_{11} \\ {x}_{12}\end{matrix} ) = ( \begin{matrix}0 \\ 0 \\ 0 \\ 0\end{matrix} ) & ( 31 - 3 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{13} \\ {x}_{14} \\ {x}_{15} \\ {x}_{16}\end{matrix} ) = ( \begin{matrix}0 \\ 0 \\ 0 \\ 0\end{matrix} ) & ( 31 - 4 )\end{matrix}$$

For each of these groups of the first matrix form equation, the unknown vector in the adjacent line of the other adjacent group is added to a constant vector, and the following first addition vector is generated.

$$\begin{matrix}( \begin{matrix}1 \\ 0 \\ 0 \\ 0\end{matrix} ) + ( \begin{matrix}0 \\ 0 \\ 0 \\ {x}_{3}\end{matrix} ) & ( 32 - 1 ) \\ ( \begin{matrix}0 \\ 0 \\ 0 \\ 0\end{matrix} ) + ( \begin{matrix}{x}_{4} \\ 0 \\ 0 \\ {x}_{9}\end{matrix} ) & ( 32 - 2 ) \\ ( \begin{matrix}0 \\ 0 \\ 0 \\ 0\end{matrix} ) + ( \begin{matrix}{x}_{8} \\ 0 \\ 0 \\ {x}_{9}\end{matrix} ) & ( 32 - 3 ) \\ ( \begin{matrix}0 \\ 0 \\ 0 \\ 0\end{matrix} ) + ( \begin{matrix}{x}_{12} \\ 0 \\ 0 \\ 0\end{matrix} ) & ( 32 - 4 )\end{matrix}$$

When the constant vectors in the first, second, third, and fourth groups shown in equations (31-1), (31-2), (31-3), and (31-4) are replaced with the addition vectors shown in equations (32-1), (32-2), (32-3), and (32-4), the first matrix form equation and the first and second groups are transformed as follows.

$$\begin{matrix}( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{1} \\ {x}_{2} \\ {x}_{3} \\ {x}_{4}\end{matrix} ) = ( \begin{matrix}1 \\ 0 \\ 0 \\ 0\end{matrix} ) + ( \begin{matrix}0 \\ 0 \\ 0 \\ {x}_{3}\end{matrix} ) & ( 33 - 1 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{5} \\ {x}_{6} \\ {x}_{7} \\ {x}_{8}\end{matrix} ) = ( \begin{matrix}0 \\ 0 \\ 0 \\ 0\end{matrix} ) + ( \begin{matrix}{x}_{4} \\ 0 \\ 0 \\ {x}_{9}\end{matrix} ) & ( 33 - 2 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{9} \\ {x}_{10} \\ {x}_{11} \\ {x}_{12}\end{matrix} ) = ( \begin{matrix}0 \\ 0 \\ 0 \\ 0\end{matrix} ) + ( \begin{matrix}{x}_{8} \\ 0 \\ 0 \\ {x}_{13}\end{matrix} ) & ( 33 - 3 ) \\ ( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} ) ( \begin{matrix}{x}_{13} \\ {x}_{14} \\ {x}_{15} \\ {x}_{16}\end{matrix} ) = ( \begin{matrix}0 \\ 0 \\ 0 \\ 0\end{matrix} ) + ( \begin{matrix}{x}_{12} \\ 0 \\ 0 \\ 0\end{matrix} ) & ( 33 - 4 )\end{matrix}$$

Next, an inverse matrix of the first coefficient matrix included in each group of the first matrix form equation, shown in equations (33-1), (33-2), (33-3), and (33-4), is obtained as follows.

$${( \begin{matrix}1.99 & - 1 & 0 & 0 \\ - 1 & 1.99 & - 1 & 0 \\ 0 & - 1 & 1.99 & - 1 \\ 0 & 0 & - 1 & 1.99\end{matrix} )}^{- 1} = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) \qquad ( 34 )$$

Next, the second matrix form equations in the form of “first unknown vector=inverse matrix of first coefficient matrix×first addition vector” are generated as follows, corresponding to the first, second, third, and fourth groups of the first matrix form equation, respectively.

$$\begin{matrix}( \begin{matrix}{x}_{1} \\ {x}_{2} \\ {x}_{3} \\ {x}_{4}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}1 \\ 0 \\ 0 \\ 0\end{matrix} ) + ( \begin{matrix}0 \\ 0 \\ 0 \\ {x}_{5}\end{matrix} ) & ( 35 - 1 ) \\ ( \begin{matrix}{x}_{5} \\ {x}_{6} \\ {x}_{7} \\ {x}_{8}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0 \\ 0 \\ 0 \\ 0\end{matrix} ) + ( \begin{matrix}{x}_{4} \\ 0 \\ 0 \\ {x}_{9}\end{matrix} ) & ( 35 - 2 ) \\ ( \begin{matrix}{x}_{9} \\ {x}_{10} \\ {x}_{11} \\ {x}_{12}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0 \\ 0 \\ 0 \\ 0\end{matrix} ) + ( \begin{matrix}{x}_{8} \\ 0 \\ 0 \\ {x}_{9}\end{matrix} ) & ( 35 - 3 ) \\ ( \begin{matrix}{x}_{13} \\ {x}_{14} \\ {x}_{15} \\ {x}_{16}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0 \\ 0 \\ 0 \\ 0\end{matrix} ) + ( \begin{matrix}{x}_{12} \\ 0 \\ 0 \\ 0\end{matrix} ) & ( 35 - 4 )\end{matrix}$$

Next, the adjacent line of the adjacent equation is extracted from the second matrix form equations each, thereby generating the third matrix form equation in the form of “second coefficient matrix×second unknown vector=second constant vector”. Specifically, the bottom line of equation (35-1), the top line and bottom line of equation (35-2), the top line and bottom line of equation (35-3), and the top line of equation (35-4) are first extracted, and the following simultaneous linear equation is generated.

x₄=0.208243+0.812271x₅

x₅=0.812271x₅+0.208243x₉

x₈=0.208243x₄+0.812271x₉

x₉=0.812271x₈+0.208243x₁₃ (36)

x₁₂=0.208243x₈+0.812271x₁₃

x₁₃=0.812271x₁₂

The simultaneous linear equation shown in equation (36) is converted into the form of “second coefficient matrix×second unknown vector=second constant vector” as follows, whereby the following third matrix equation is obtained:

$$M ( \begin{matrix}{x}_{4} \\ {x}_{5} \\ {x}_{8} \\ {x}_{9} \\ {x}_{12} \\ {x}_{13}\end{matrix} ) = ( \begin{matrix}0.208243 \\ 0 \\ 0 \\ 0 \\ 0 \\ 0\end{matrix} ) \qquad ( 37 )$$

where M is a second coefficient matrix, and is expressed below.

$$M = ( \begin{matrix}1 & - 0.812271 & 0 & 0 & & \\ - 0.812271 & 1 & 0 & - 0.208243 & & \\ - 0208243 & 0 & 1 & - 0.812271 & & \\ 0 & 0 & - 0.812271 & 1 & 0 & - 0.208243 \\ & & - 0.208243 & 0 & 1 & - 0.812271 \\ & & & & - 0.812271 & 1\end{matrix} ) \qquad ( 38 )$$

Next, in order to ensure a well-balanced third matrix form equation, the third matrix form equation is transformed as follows. From equation (35-1), assume that x₁=0.812271+0.208243x₅. From equation (35-4), assume that x₁₆=0.208243x₁₂. At this time, the following is used as a coefficient matrix M.

$$M = ( \begin{matrix}1 & 0 & - 0.208243 & & & & & \\ 0 & 1 & - 0.812271 & 0 & 0 & & & \\ 0 & - 0.812271 & 1 & 0 & - 0.208243 & & & \\ 0 & - 0.208243 & 0 & 1 & - 0.812271 & & & \\ 0 & 0 & 0 & - 0.812271 & 1 & 0 & - 0.208243 & 0 \\ & & & - 0.208243 & 0 & 1 & - 0.812271 & 0 \\ & & & & & - 0.812271 & 1 & 0 \\ & & & & & - 0.208243 & 0 & 1\end{matrix} ) \qquad ( 39 )$$

In this manner, the third matrix form equation is transformed as follows.

$$M ( \begin{matrix}{x}_{1} \\ {x}_{4} \\ {x}_{5} \\ {x}_{8} \\ {x}_{9} \\ {x}_{12} \\ {x}_{13} \\ {x}_{16}\end{matrix} ) = ( \begin{matrix}0.812271 \\ 0.208243 \\ 0 \\ 0 \\ 0 \\ 0 \\ 0 \\ 0\end{matrix} ) \qquad ( 40 )$$

Next, the third matrix form equation is divided by the inputted division number of the second hierarchy=2. For example, as shown below, the third matrix form equation is divided into a first group of the upper four lines and a second group of the lower four lines.

$$\begin{matrix}( \begin{matrix}1 & 0 & - 0.208243 & 0 \\ 0 & 1 & - 0.812271 & 0 \\ 0 & - 0.812271 & 1 & 0 \\ 0 & - 0.208243 & 0 & 1\end{matrix} ) ( \begin{matrix}{x}_{1} \\ {x}_{4} \\ {x}_{5} \\ {x}_{6}\end{matrix} ) = ( \begin{matrix}0.812271 \\ 0.208243 \\ 0 \\ 0\end{matrix} ) & ( 41 - 1 ) \\ ( \begin{matrix}1 & 0 & - 0.208243 & 0 \\ 0 & 1 & - 0.812271 & 0 \\ 0 & - 0.812271 & 1 & 0 \\ 0 & - 0.208243 & 0 & 1\end{matrix} ) ( \begin{matrix}{x}_{9} \\ {x}_{12} \\ {x}_{13} \\ {x}_{16}\end{matrix} ) = ( \begin{matrix}0 \\ 0 \\ 0 \\ 0\end{matrix} ) & ( 41 - 2 )\end{matrix}$$

The second unknown vector in the adjacent line of the other adjacent group is added to a constant vector for each of the groups of these third matrix form equations, and the following second addition vector is generated.

$$\begin{matrix}( \begin{matrix}0.812271 \\ 0.208243 \\ 0 \\ 0\end{matrix} ) + ( \begin{matrix}0 \\ 0 \\ 0.208243 {x}_{9} \\ 0.812271 {x}_{9}\end{matrix} ) & ( 42 - 1 ) \\ ( \begin{matrix}0 \\ 0 \\ 0 \\ 0\end{matrix} ) + ( \begin{matrix}0.812271 {x}_{8} \\ 0.208243 {x}_{6} \\ 0 \\ 0\end{matrix} ) & ( 42 - 2 )\end{matrix}$$

When the constant vector of the first and second groups each shown in equations (41-1) and (41-2) each is replaced with the addition vector shown in equations (42-1) and (42-2) each, the first and second groups of the third matrix form equation are transformed as follows.

$$\begin{matrix}( \begin{matrix}1 & 0 & - 0.208243 & 0 \\ 0 & 1 & - 0.812271 & 0 \\ 0 & - 0.812271 & 1 & 0 \\ 0 & - 0.208243 & 0 & 1\end{matrix} ) ( \begin{matrix}{x}_{1} \\ {x}_{4} \\ {x}_{5} \\ {x}_{6}\end{matrix} ) = ( \begin{matrix}0.812271 \\ 0.208243 \\ 0 \\ 0\end{matrix} ) + ( \begin{matrix}0 \\ 0 \\ 0.208243 {x}_{9} \\ 0.812271 {x}_{9}\end{matrix} ) & ( 43 - 1 ) \\ ( \begin{matrix}1 & 0 & - 0.208243 & 0 \\ 0 & 1 & - 0.812271 & 0 \\ 0 & - 0.812271 & 1 & 0 \\ 0 & - 0.208243 & 0 & 1\end{matrix} ) ( \begin{matrix}{x}_{9} \\ {x}_{12} \\ {x}_{13} \\ {x}_{16}\end{matrix} ) = ( \begin{matrix}0 \\ 0 \\ 0 \\ 0\end{matrix} ) + ( \begin{matrix}0.812271 {x}_{8} \\ 0.208243 {x}_{6} \\ 0 \\ 0\end{matrix} ) & ( 43 - 2 )\end{matrix}$$

Next, an inverse matrix of the third coefficient matrix included in each group of the third matrix form equation is obtained as shown below.

$${( \begin{matrix}1 & 0 & - 0.208243 & 0 \\ 0 & 1 & - 0.812271 & 0 \\ 0 & - 0.812271 & 1 & 0 \\ 0 & - 0.208243 & 0 & 1\end{matrix} )}^{- 1} = ( \begin{matrix}1 & 0.497182 & 0.612089 & 0 \\ 0 & 2.93931 & 2.38751 & 0 \\ 0 & 2.38751 & 2.93931 & 0 \\ 0 & 0.612089 & 0.497182 & 1\end{matrix} ) \qquad ( 44 )$$

Next, the fourth matrix form equation of the first and second groups each in the form of “third unknown vector=third coefficient matrix×third addition vector” is generated corresponding to the first and second groups each of the third matrix form equation, respectively, as shown in the following equation.

$$\begin{matrix}( \begin{matrix}{x}_{1} \\ {x}_{4} \\ {x}_{5} \\ {x}_{8}\end{matrix} ) = ( \begin{matrix}1 & 0.497182 & 0.612089 & 0 \\ 0 & 2.93931 & 2.38751 & 0 \\ 0 & 2.38751 & 2.93931 & 0 \\ 0 & 0.612089 & 0.497182 & 1\end{matrix} ) [ ( \begin{matrix}0.812271 \\ 0.208243 \\ 0 \\ 0\end{matrix} ) + ( \begin{matrix}0 \\ 0 \\ 0.208243 {x}_{9} \\ 0.812271 {x}_{9}\end{matrix} ) ] & ( 45 - 1 ) \\ ( \begin{matrix}{x}_{9} \\ {x}_{12} \\ {x}_{13} \\ {x}_{16}\end{matrix} ) = ( \begin{matrix}1 & 0.497182 & 0.612089 & 0 \\ 0 & 2.93931 & 2.38751 & 0 \\ 0 & 2.38751 & 2.93931 & 0 \\ 0 & 0.612089 & 0.497182 & 1\end{matrix} ) ( \begin{matrix}0.812271 {x}_{8} \\ 0.208243 {x}_{8} \\ 0 \\ 0\end{matrix} ) & ( 45 - 2 )\end{matrix}$$

Next, the adjacent line of the other adjacent equation is extracted from the fourth matrix form equations each, thereby generating the fifth matrix form equations each in the form of “second coefficient matrix×second unknown vector second constant vector”. Specifically, the bottom line of equation (45-1) and the top line of equation (45-2) are first extracted, and the following simultaneous linear equation is generated.

x₈=0.612089×0.208243+0.497182×0.208243x₉+0.812271x₉

x₉=0.812271x₈+0.497182×0.208243x₈ (46)

When a matrix form equation is generated from this simultaneous linear equation, the generated matrix form equation is obtained as the following sixth matrix form equation which is expressed as “coefficient matrix×unknown vector=constant vector”.

$$( \begin{matrix}1 & - 0.915805 \\ - 0.915805 & 1\end{matrix} ) ( \begin{matrix}{x}_{8} \\ {x}_{9}\end{matrix} ) = ( \begin{matrix}0.127463 \\ 0\end{matrix} ) \qquad ( 47 )$$

Then, an inverse matrix of the coefficient matrix in the sixth matrix form equation is obtained.

$${( \begin{matrix}1 & - 0.915805 \\ - 0.915805 & 1\end{matrix} )}^{- 1} = ( \begin{matrix}6.1996 & 5.67762 \\ 5.67762 & 6.1996\end{matrix} ) \qquad ( 48 )$$

From these inverse matrix and constant vector, the values of unknowns x₈ and x₉ are obtained from the following matrix form equation.

$$\begin{matrix}( \begin{matrix}{x}_{8} \\ {x}_{9}\end{matrix} ) = ( \begin{matrix}6.1996 & 5.67762 \\ 5.67762 & 6.1996\end{matrix} ) ( \begin{matrix}0.127463 \\ 0\end{matrix} ) \\ = ( \begin{matrix}0.790219 \\ 0.723687\end{matrix} )\end{matrix} \qquad ( 49 )$$

When the unknowns x₈ and x₉ are obtained from this matrix form equation, the values of the unknowns x₈ and x₉ are substituted into the fifth matrix form equation shown in equations (45-1) and (45-2). In this manner, the values of unknowns x₁, x₄, x₅, x₁₂, x₁₃, and x₁₆ are obtained from the following matrix form equation. In accordance with the above processing, all the unknowns in the fifth matrix form equation are obtained.

$$\begin{matrix}( \begin{matrix}{x}_{1} \\ {x}_{4} \\ {x}_{5} \\ {x}_{8}\end{matrix} ) = ( \begin{matrix}1 & 0.497182 & 0.612089 & 0 \\ 0 & 2.93931 & 2.38751 & 0 \\ 0 & 2.38751 & 2.93931 & 0 \\ 0 & 0.612089 & 0.497182 & 1\end{matrix} ) ( \begin{matrix}0.812271 \\ 0.208243 \\ 0.150702 \\ 0.58783\end{matrix} ) = ( \begin{matrix}1.00805 \\ 0.971893 \\ 0.940143 \\ 0.790219\end{matrix} ) & \text{(50-1)} \\ ( \begin{matrix}{x}_{9} \\ {x}_{12} \\ {x}_{13} \\ {x}_{16}\end{matrix} ) = ( \begin{matrix}1 & 0.497182 & 0.612089 & 0 \\ 0 & 2.93931 & 2.38751 & 0 \\ 0 & 2.38751 & 2.93931 & 0 \\ 0 & 0.612089 & 0.497182 & 1\end{matrix} ) ( \begin{matrix}0.641872 \\ 0.164557 \\ 0 \\ 0\end{matrix} ) = ( \begin{matrix}0.723687 \\ 0.483684 \\ 0.392883 \\ 0.100724\end{matrix} ) & \text{(50-2)}\end{matrix}$$

The values of the unknowns x₁, x₄, x₅, x₆, x₉, x₁₂, x₁₃, and x₁₆ obtained in accordance with the above processing are substituted into the second matrix form equations shown in equations (35-1), (35-2), (35-3), and (35-4) each. Then, the values of the remaining unknowns x₂, x₃, x₆, x₇, x₁₀, x₁₁, x₁₄, and x₁₅ are obtained from the following matrix form equation. In this manner, all of the 16 unknowns in the simultaneous linear equation are obtained.

$$\begin{matrix}\begin{matrix}( \begin{matrix}{x}_{1} \\ {x}_{2} \\ {x}_{3} \\ {x}_{4}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}1 \\ 0 \\ 0 \\ 0.940143\end{matrix} ) \\ = ( \begin{matrix}1.00805 \\ 1.00602 \\ 0.993924` \\ 0.971893\end{matrix} )\end{matrix} & \text{(51-1)} \\ \begin{matrix}( \begin{matrix}{x}_{5} \\ {x}_{6} \\ {x}_{7} \\ {x}_{8}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0.971893 \\ 0 \\ 0 \\ 0.723687\end{matrix} ) \\ = ( \begin{matrix}0.940143 \\ 0.898991 \\ 0.848849 \\ 0.790219\end{matrix} )\end{matrix} & \text{(51-2)} \\ \begin{matrix}( \begin{matrix}{x}_{9} \\ {x}_{10} \\ {x}_{11} \\ {x}_{12}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0.790219 \\ 0 \\ 0 \\ 0.392883\end{matrix} ) \\ = ( \begin{matrix}0.723687 \\ 0.649918 \\ 0.569649 \\ 0.483684\end{matrix} )\end{matrix} & \text{(51-3)} \\ \begin{matrix}( \begin{matrix}{x}_{13} \\ {x}_{14} \\ {x}_{15} \\ {x}_{16}\end{matrix} ) = ( \begin{matrix}0.812271 & 0.616419 & 0.414403 & 0.208243 \\ 0.616419 & 1.22667 & 0.824661 & 0.414403 \\ 0.414403 & 0.824661 & 1.22667 & 0.616419 \\ 0.208243 & 0.414403 & 0.616419 & 0.812271\end{matrix} ) ( \begin{matrix}0.483684 \\ 0 \\ 0 \\ 0\end{matrix} ) \\ = ( \begin{matrix}0.392883 \\ 0.298152 \\ 0.20044 \\ 0.100724\end{matrix} )\end{matrix} & \text{(51-4)}\end{matrix}$$

As in the present embodiment, the matrix form equation obtained from the simultaneous linear equation is divided according to the hierarchically processed order, only the boundary portion of the divided matrix form equation is fetched, and the compressed matrix form equation is generated. These processes are repeated, and the compressed matrix form equation is solved in order reversed from that of division, whereby all the unknowns in the original matrix form equation is finally obtained, making it possible to obtain a complex simultaneous linear equation in very simple procedure, and moreover, in a business-like manner.

When analytical computation is actually carried out by using a computation program for simultaneous linear equation or a computer device for simultaneous linear equation according to the present embodiment, the computation time of matrix form equation can be significantly reduced, as shown in FIG. 9A and FIG. 9B. FIG. 9A is a chart showing the measurement result of time required for solving a matrix form equation having a coefficient matrix of 1,000,000 lines×1,000,000 columns, which is obtained in a case of carrying out vibration response analysis of 10 particles system. When the division number of the first hierarchy (first division number) is defined as 250, and the division number of the second hierarchy (second division number) is defined as 2, the matrix form equation having the coefficient matrix of 1,000,000 lines×1,000,000 columns can be solved within 2,650 seconds. When the first division number is defined as 1,000, and the second division number is defined as 25, the same matrix form equation can be solved within 350 seconds. When a relationship between each of the first and second division numbers and the computation time is depicted by a three-dimensional bar graph, the relationship as shown in FIG. 9B is obtained. From FIG. 9A and FIG. 9B, when the matrix form equation having the coefficient matrix of 1,000,000 lines×1,000,000 columns is solved, it is found that the computation time is reduced as the first and second division numbers increase within a certain range.

In this way, even in a simultaneous linear equation having a very large number of unknowns, its solution can be obtained within a short time. Therefore, when a target system is analyzed in accordance with the present embodiment, simulation analysis of physical phenomena such as vibration transmission state in building or room temperature distribution state can be carried out precisely.

Although the present embodiment has described a case of solving a simultaneous linear equation by carrying out division twice, i.e., by defining a hierarchically processed order as 2, it is possible to solve such simultaneous equation by using analysis procedures similar to the above, even in the case where division is carried out three times or more.

As has been described above, according to the present embodiment, a matrix form equation having its large coefficient matrix is automatically divided into that having its small coefficient matrix based on analysis conditions such as initial condition, boundary condition, time step width time step number, space step width, space step number, and solid state property value and division number. Therefore, a finally obtained matrix form equation can be changed to a very small matrix form equation even without high-level technical knowledge or experience. Since a restriction of size of matrix that can be handled is significantly alleviated, for example, even when physical phenomena such as vibration transmission state or room temperature distribution state are analyzed in a simulative manner, there is no need to taking an account into analytical model or to restrict the analysis range at the expense of analysis precision. A multiple simultaneous linear equation can be solved without high-level technical knowledge or experience. In addition, an inverse matrix of the coefficient matrix in the divided matrix form equation is solved within a very short time, and thus, the analysis result with high precision can be obtained at a much higher than conventional one.

Now, procedures for actually carrying out analytical computation or display format of the analysis result will be described in accordance with the present embodiment.

### EXAMPLE 1

Vibration analysis for obtaining a response displacement time history in 10 -story building is carried out. An operator inputs the following data from the input device 14.

Number of vibrators “n”

Number of steps on time axis “f”

Damping matrix C (square matrix of order “n”)

Rigidity matrix K (square matrix of order “n”)

Mass matrix M (square matrix of order “n”)

External force F (number “n”×f)

Initial condition I (number “n”)

Boundary condition B (number “n”)

First division number based on physical requirement that is the number of steps on time axis (f/first division number=integer)

Second division number based on physical requirement that is the number of steps on time axis (first division number/second division number=integer)

When the above data is inputted from the input device 14, the CPU 120 causes the subsidiary memory to store the data in its predetermined region of the subsidiary memory 160. Next, the CPU 120 analyzes the inputted data in the following procedure.

Step S401: A matrix form equation is generated from a multiple simultaneous linear equation, and the generated matrix form equation is divided by a first division number. The matrix form equation after divided is stored in a predetermined region of the subsidiary memory 160. The stored matrix form equation is not a matrix form equation before divided, and thus, the required storage area is significantly reduced.

Step S402: A vector of external force is grouped, and the grouped vector is stored in a predetermined region of the subsidiary memory 160.

Step S403: An inverse matrix of a coefficient matrix relevant to an unknown to be obtained in the matrix form equation after divided is obtained, and the obtained matrix is stored in a predetermined region of the subsidiary memory 160.

Step S404: A equation located at the boundary portion is generated or computed by using the inverse matrix of the matrix form equation after divided, initial condition, boundary condition, external force and the like, and a value of the equation located at the boundary portion is obtained. The value of the equation located at the boundary portion is stored in a predetermined region of the subsidiary memory 160.

Step S405: A value of the equation at the boundary portion required to obtain the matrix form equation after divided is called from the subsidiary memory 160, and further, an inverse matrix required to obtain the matrix form equation after divided is called from the subsidiary memory 160. By these processes, all the matrix form equations after divided can be obtained. The similar processing is applied to all the divided matrix form equations (corresponding to multiple simultaneous linear equation), and all the required unknowns are obtained. Of course, it is not always necessary to generate or store a coefficient matrix before divided. In short, the coefficient matrix after divided may be generated or stored.

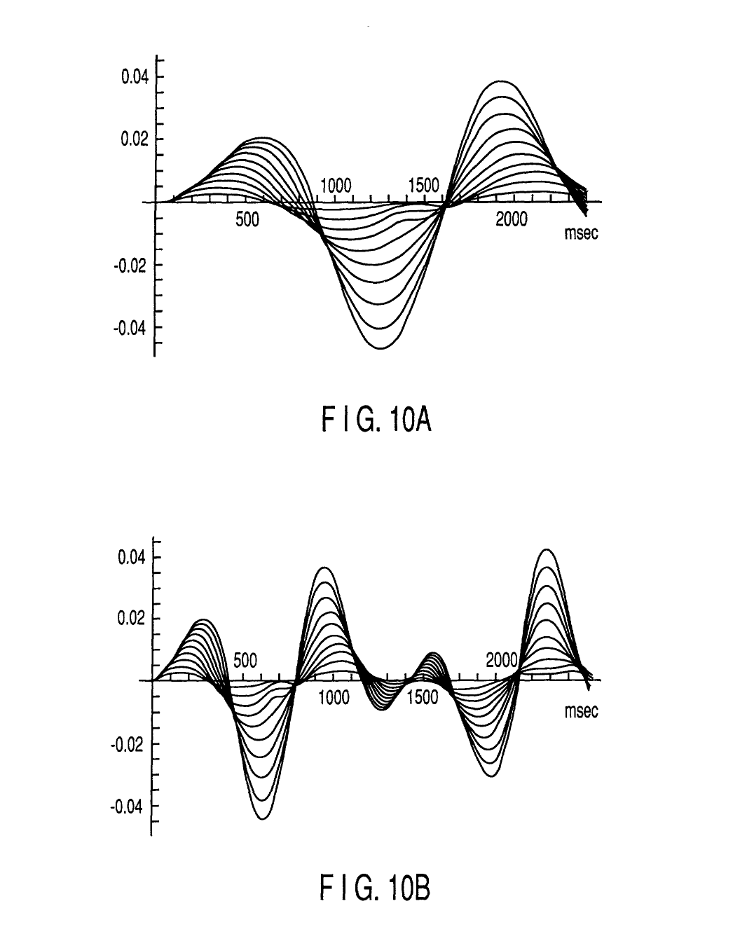

The above processing is carried out as well in a case of carrying out second division. The analysis result obtained in accordance with the above procedure is displayed by the output device 15 as a graph of a response displacement time history of building as shown in FIG. 10A and FIG. 10B. FIG. 10B shows a time axis in a compressive manner relevant to FIG. 10A.

### EXAMPLE 2

A case of carrying out thermal transmission analysis of a room temperature distribution when a heat source is placed in a room will be described here. In this example, a planar Laplace's equation is used.

An operator inputs the following data from the input device 14.

Number of vertical steps “n”

Number of horizontal steps “m”

Boundary condition B (number 2n+2m)

Initial condition I (number n×m)

First division number based on physical requirement (when n≧m, n/first division number=integer)

Second division number based on physical requirement (first division number/second division number=integer)

When the above data is inputted from the input device 14, the CPU 120 causes the subsidiary memory 160 to store the data its predetermined region. Next, the CPU 120 analyzes the inputted data in accordance with the following procedure.

Step S501: A matrix form equation is generated from a multi-dimensional, simultaneous linear equation, and the generated matrix form equation is divided by a first division number. The matrix form equation after divided is stored in a predetermined region of the subsidiary memory 160. The stored matrix form equation is not a matrix form equation before divided, and thus, the required storage area is significantly reduced.

Step S502: The initial condition and boundary condition are grouped, and are stored in a predetermined region of the subsidiary memory 160.

Step S503: An inverse matrix of the coefficient matrix multiplied for an unknown to be obtained in the matrix form equation after divided is obtained, and is stored in a predetermined region of the subsidiary memory 160.

Step S504: An equation located at the boundary portion is generated or computed by using the inverse matrix of the matrix form equation after divided, initial condition, and boundary condition, and a value of the equation located at the boundary portion is obtained. The value of the equation located at the boundary portion is stored in a predetermined region of the subsidiary memory 160.

Step S505: A value of the equation located at the boundary portion required to obtain the matrix form equation after divided is obtained from the subsidiary memory 160. An inverse matrix required to obtain the matrix form equation after divided is called from the subsidiary memory 160. By these processes, all the matrix form equations after divided can be obtained. The similar processing is applied to the all the divided matrix form equations (corresponding to multi-dimensional simultaneous equation), and all the required unknowns are obtained.

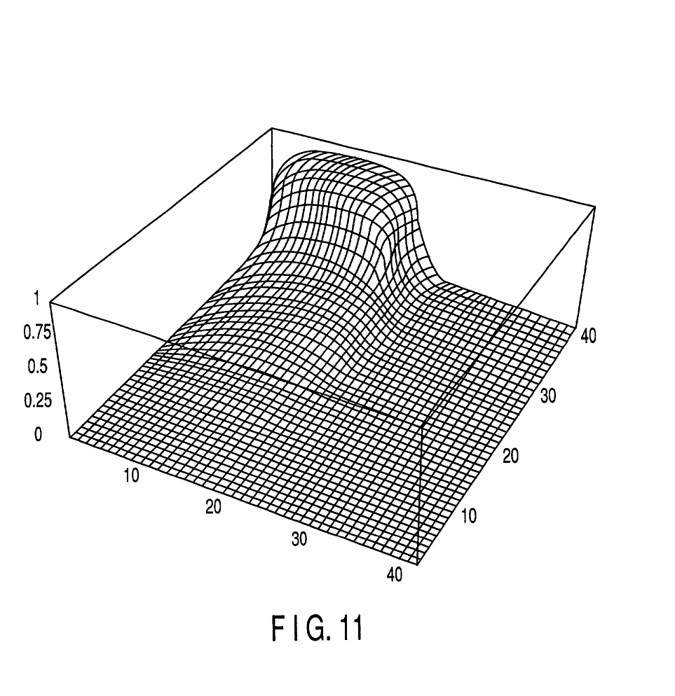

The above processing is carried out as well in a case of carrying out second division. The analysis result obtained in accordance with the above procedures is displayed on the output device 15 as a graph showing a room temperature distribution as shown in FIG. 11.

A computation program for a simultaneous linear equation for use in each of the embodiments of the present invention is recorded in a computer readable recording medium such as magneto-optical disk, optical disk, flexible disk, rigid disk, magnetic tape, or flash memory. A computer can solve a simultaneous linear equation within a short time by reading the computation program recorded in any of these recording media. For example, as a computation program for a simultaneous linear equation, the analysis procedures presented in the present embodiment are provided to the computer via various kinds of media described above or a network such as Internet or Intranet. This computer carries out division and compression of a matrix form equation by executing the computation program, and can obtain a solution of a simultaneous linear equation within a very short time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A computer program product configured to store program instructions for execution on a computer system enabling the computer system to perform:
converting a simultaneous equation to analyze a physical target system into a first equation in the form of “first coefficient matrix×first unknown vector=first constant vector”;
dividing said first equation into a plurality of groups;
generating an addition vector by adding a first unknown vector having connective relation of the adjacent group to said first constant vector for each group of said first equation;
generating a plurality of second equations each in the form of “first unknown vector=inverse matrix of first coefficient matrix×addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from said plurality of second equations;
obtaining values of unknowns included in said second unknown vector by using an inverse matrix of said second coefficient matrix;
obtaining values of unknowns included in said simultaneous linear equation by substituting the obtained values of the unknowns included in said second unknown vector into said plurality of second equations; and
outputting the obtained values of the unknowns included in said simultaneous linear equation as an analysis result of said target system.

2. A computer program product configured to store program instructions for execution on a computer system enabling the computer system to perform:
converting a simultaneous equation to analyze a physical target system into a first equation in the form of “first coefficient matrix×first unknown vector=first constant vector”;
dividing said first equation into a plurality of groups;
generating at least one of compressed third equation in the form of “second coefficient matrix×second unknown vector=second constant vector” by extracting equation having connective relation from said plurality of second equations;
generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from each of said plurality of second equations;
dividing said third equation into a plurality of groups;
generating a second addition vector by adding a second unknown vector having connective relation of the adjacent group to said second constant vector for each group of said third equation;
generating a plurality of forth equations each in the form of “second unknown vector=inverse matrix of second coefficient matrix×second addition vector” corresponding to each group of said third equation, respectively, by using said second unknown vector, said second addition vector, and an inverse matrix of said second coefficient matrix;
generating at least one of compressed fifth equation in the form of “third coefficient matrix×third unknown vector=third constant vector” by extracting equation having connective relation from each of said plurality of fourth equations;
obtaining values of unknowns included in said third unknown vector by using an inverse matrix of said third coefficient matrix;
obtaining values of unknowns included in said second unknown vector by substituting the obtained values of the unknowns included in said third unknown vector into said plurality of fourth equations;
obtaining values of unknowns included in said simultaneous linear equation by substituting the obtained values of the unknowns included in said second unknown vector into said plurality of second equations; and
outputting the obtained values of the unknowns included in said simultaneous linear equation as an analysis result of said target system.

3. A computer program product configured to store program instructions for execution on a computer system enabling the computer system to perform:
setting a repetition count N of division and compression of a equation;
converting a simultaneous equation to analyze a physical target system into a first equation in the form of “first coefficient matrix×first unknown vector=first constant vector”;
dividing said first equation into a plurality of groups;
generating a first addition vector by adding a first unknown vector having connective relation of the adjacent group to said first constant vector for each group of said first equation;
generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from said plurality of second equations;
repeating dividing said first equation into a plurality of groups, generating said first addition vector, generating a plurality of second equations each, and generating said third equation said count N times by replacing said first equation with said third equation;
obtaining values of unknowns included in said second unknown vector by using an inverse matrix of said second coefficient matrix obtained after said repetition;
obtaining values of unknowns included in said first unknown vector by substituting the obtained values of the unknowns included in said second unknown vector into said first equation;
obtaining values of unknowns included in said simultaneous linear equation by repeating obtaining values of the unknowns included in said second unknown vector and obtaining values of the unknowns included in said first unknown vector said count N times; and
outputting the obtained values of the unknowns included in said simultaneous linear equation as an analysis result of said target system.

4. An analysis method for a physical target system comprising:
converting a simultaneous equation to analyze a physical target system into a first equation in the form of “first coefficient matrix×first unknown vector=first constant vector”;
dividing said first equation into a plurality of groups;
generating an addition vector by adding a first unknown vector having connective relation of the adjacent group to said first constant vector for each group of said first equation;
generating a plurality of second equations each in the form of “first unknown vector=inverse matrix of first coefficient matrix×addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from said plurality of second equations;
obtaining values of unknowns included in said second unknown vector by using an inverse matrix of said second coefficient matrix;
obtaining values of unknowns included in said simultaneous linear equation by substituting the obtained values of the unknowns included in said second unknown vector into said plurality of second equations; and
outputting the obtained values of the unknowns included in said simultaneous linear equation as an analysis result of said target system.

5. An analysis method for a physical target system comprising:
converting a simultaneous equation to analyze a physical target system into a first equation in the form of “first coefficient matrix×first unknown vector=first constant vector”;
dividing said first equation into a plurality of groups;
generating at least one of compressed third equation in the form of “second coefficient matrix×second unknown vector=second constant vector” by extracting equation having connective relation from said plurality of second equations;
generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from each of said plurality of second equations;
dividing said third equation into a plurality of groups;
generating a second addition vector by adding a second unknown vector having connective relation of the adjacent group to said second constant vector for each group of said third equation;
generating a plurality of forth equations each in the form of “second unknown vector=inverse matrix of second coefficient matrix×second addition vector” corresponding to each group of said third equation, respectively, by using said second unknown vector, said second addition vector, and an inverse matrix of said second coefficient matrix;
generating at least one of compressed fifth equation in the form of “third coefficient matrix×third unknown vector=third constant vector” by extracting equation having connective relation from each of said plurality of fourth equations;
obtaining values of unknowns included in said third unknown vector by using an inverse matrix of said third coefficient matrix;
obtaining values of unknowns included in said second unknown vector by substituting the obtained values of the unknowns included in said third unknown vector into said plurality of fourth equations;
obtaining values of unknowns included in said simultaneous linear equation by substituting the obtained values of the unknowns included in said second unknown vector into said plurality of second equations; and
outputting the obtained values of the unknowns included in said simultaneous linear equation as an analysis result of said target system.

6. An analysis method for a physical target system comprising:
setting a repetition count N of division and compression of a equation;
converting a simultaneous equation to analyze a physical target system into a first equation in the form of “first coefficient matrix×first unknown vector=first constant vector”;
dividing said first equation into a plurality of groups;
generating a first addition vector by adding a first unknown vector having connective relation of the adjacent group to said first constant vector for each group of said first equation;
generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from said plurality of second equations;
repeating dividing said first equation into a plurality of groups, generating said first addition vector, generating a plurality of second equations each, and generating said third equation said count N times by replacing said first equation with said third equation;
obtaining values of unknowns included in said second unknown vector by using an inverse matrix of said second coefficient matrix obtained after said repetition;
obtaining values of unknowns included in said first unknown vector by substituting the obtained values of the unknowns included in said second unknown vector into said first equation;
obtaining values of unknowns included in said simultaneous linear equation by repeating obtaining values of the unknowns included in said second unknown vector and obtaining values of the unknowns included in said first unknown vector said count N times; and
outputting the obtained values of the unknowns included in said simultaneous linear equation as an analysis result of said target system.

7. An analysis apparatus for a physical target system comprising:
means for converting a simultaneous equation to analyze a physical target system into a first equation in the form of “first coefficient matrix×first unknown vector=first constant vector”;
means for dividing said first equation into a plurality of groups;
means for generating an addition vector by adding a first unknown vector having connective relation of the adjacent group to said first constant vector for each group of said first equation;
means for generating a plurality of second equations each in the form of “first unknown vector=inverse matrix of first coefficient matrix×addition vector” corresponding to each group of said first equation, respectively, by using said first unknown vector, said addition vector, and an inverse matrix of said first coefficient matrix;
means for generating at least one of compressed third equation in the form of “second coefficient matrix×second unknown vector=second constant vector” by extracting equation having connective relation from said plurality of second equations;
means for obtaining values of unknowns included in said second unknown vector by using an inverse matrix of said second coefficient matrix;
means for obtaining values of unknowns included in said simultaneous linear equation by substituting the obtained values of the unknowns included in said second unknown vector into said plurality of second equations; and
means for outputting the obtained values of the unknowns included in said simultaneous linear equation as an analysis result of said target system.

8. An analysis method for a physical target system comprising:
means for converting a simultaneous equation to analyze a physical target system into a first equation in the form of “first coefficient matrix×first unknown vector=first constant vector”;
dividing said first equation into a plurality of groups;
generating at least one of compressed third equation in the form of “second coefficient matrix×second unknown vector=second constant vector” by extracting equation having connective relation from said plurality of second equations;
generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
generating at least one of compressed third equation in the form of “second coefficient matrix×second unknown vector=second constant vector” by extracting equation having connective relation from each of said plurality of second equations;
dividing said third equation into a plurality of groups;
generating a second addition vector by adding a second unknown vector having connective relation of the adjacent group to said second constant vector for each group of said third equation;
generating a plurality of forth equations each in the form of “second unknown vector=inverse matrix of second coefficient matrix×second addition vector” corresponding to each group of said third equation, respectively, by using said second unknown vector, said second addition vector, and an inverse matrix of said second coefficient matrix;
generating at least one of compressed fifth equation in the form of “third coefficient matrix×third unknown vector=third constant vector” by extracting equation having connective relation from each of said plurality of fourth equations;
obtaining values of unknowns included in said third unknown vector by using an inverse matrix of said third coefficient matrix;
obtaining values of unknowns included in said second unknown vector by substituting the obtained values of the unknowns included in said third unknown vector into said plurality of fourth equations;
obtaining values of unknowns included in said simultaneous linear equation by substituting the obtained values of the unknowns included in said second unknown vector into said plurality of second equations; and
outputting the obtained values of the unknowns included in said simultaneous linear equation as an analysis result of said target system.

9. An analysis apparatus for a physical target system comprising:
means for setting a repetition count N of division and compression of a equation;
means for converting a simultaneous equation to analyze a physical target system into a first equation in the form of “first coefficient matrix×first unknown vector=first constant vector”;
means for dividing said first equation into a plurality of groups;
means for generating a first addition vector by adding a first unknown vector having connective relation of the adjacent group to said first constant vector for each group of said first equation;
means for generating a plurality of second equations each in the form of “first unknown vector=inverse matrix of first coefficient matrix×first addition vector” corresponding to each group of said first equation, respectively, by using said first unknown vector, said addition vector, and an inverse matrix of said first coefficient matrix;
means for generating at least one of compressed third equation in the form of “second coefficient matrix×second unknown vector=second constant vector” by extracting equation having connective relation from said plurality of second equations;
means for repeating dividing said first equation into a plurality of groups, generating said first addition vector, generating a plurality of second equations each, and generating said third equation said count N times by replacing said first equation with said third equation;
means for obtaining values of unknowns included in said second unknown vector by using an inverse matrix of said second coefficient matrix obtained after said repetition;
means for obtaining values of unknowns included in said first unknown vector by substituting the obtained values of the unknowns included in said second unknown vector into said first equation;
means for obtaining values of unknowns included in said simultaneous linear equation by repeating obtaining values of the unknowns included in said second unknown vector and obtaining values of the unknowns included in said first unknown vector said count N times; and
means for outputting the obtained values of the unknowns included in said simultaneous linear equation as an analysis result of said target system.

10. The analysis method according to claim 6, wherein said first equation is generated by discretizing a differential equation which simulates physical phenomena of said target system, and transforming the discretized equation.

11. The analysis method according to claim 6, wherein said first equation is divided into said plurality of groups after a boundary condition has been applied.

12. The analysis method according to claim 6, wherein said simultaneous equation is provided for vibration analysis of said target system.

13. The analysis method according to claim 6, wherein said simultaneous equation is provided for thermal transmission analysis of a temperature distribution of said target.

14. An apparatus which controls a physical target system comprising:
an analysis apparatus according to claim 9; and
a device which generates control data to be supplied to said target system in accordance with the analysis result from the analysis apparatus.

15. An apparatus which monitors an operational state of a physical target system comprising:
an analysis apparatus according to claim 9; and
a device which displays the operational state of said target system in accordance with the analysis result from the analysis apparatus.

16. An apparatus which controls and monitors a physical target system comprising:
an analysis apparatus according to claim 9;
a device which generates control data to be supplied to said target system in accordance with the analysis result from the analysis apparatus; and
a device which displays the operational state of said target system in accordance with the analysis result of the analysis device.
